(19) United States
(12) Patent Application Publication
(10) Pub. No.: US 2010/0107130 A1
(43) Pub. Date: Apr. 29, 2010

(54) 1XN BLOCK BUILDER FOR 1XN VLSI DESIGN

(75) Inventors: Benjamin J. Bowers, Cary, NC (US); Matthew W. Baker, Holly Springs, NC (US); Anthony Correale, JR., Raleigh, NC (US); Irfan Rashid, Cary, NC (US); Paul M. Steinmetz, Holly Springs, NC (US)

Correspondence Address: IBM CORPORATION (RTP);C/O SCHUBERT OSTERRIEDER & NICKELSON PLLC, 6013 CANNON MOUNTAIN DRIVE, S14, AUSTIN, TX, 78749, US

(73) Assignee: INTERNATIONAL BUSINESS MACHINES CORPORATION, Armonk, NY (US)

(21) Appl. No.: 12/256,594

(22) Filed: Oct. 23, 2008

(51) Int. Cl. G06F 17/50

(52) U.S. Cl. 716/5; 716/1; 716/12

(57) ABSTRACT

Embodiments that generate 1×N building block representations for an IC design via a GUI of a 1×N block builder are disclosed. Some embodiments enable, via a GUI, selection of a logical function for a 1×N building block. The embodiments also comprise enabling selection of an implementation from a number of implementations of the logical function and automatically generating a 1×N building block representation of the logical function based on the selected implementation. The generated 1×N building block representation comprises an RTL description of the 1×N building block. Further embodiments comprise an apparatus having a GUI generator, a logical function selector to select a logical function, an implementation selector to select an implementation of the logical function from a number of implementations, and a 1×N building block generator to generate a 1×N building block representation of the 1×N building block based on the selected implementation.

### BACKGROUND

The present invention generally relates to the field of integrated circuits. More particularly, the present invention relates to methods, systems, and computer program products to generate 1×N building blocks for an integrated circuit design via a graphical user interface (GUI) of a 1×N block builder. The integrated circuits of today commonly have hundreds of millions of transistors on a single chip, with many critical circuit features having measurements in the deep sub-micron range. As manufacturers implement more and more circuit elements in smaller and smaller silicon substrate surface areas, engineers and designers develop hardware and software tools to automate much of the integrated circuit design and manufacturing process.

The classical design methodology for designing and manufacturing integrated circuits no longer begins with a circuit diagram. Instead, the methodology most often begins with a software program that describes the behavior or functionality of a circuit. This software program is a source code description that defines an algorithm to be performed with limited implementation details. Designers direct behavioral synthesis tools to convert the source code description into a register transfer level (RTL) description. The RTL description is used to ultimately generate a netlist that includes a list of components in the circuit and the interconnections between the components. This netlist is used to create the physical integrated circuit.

Further, the classical design methodology for designing and manufacturing integrated circuits employs an open-loop design process whereby the activities of logic capture and physical realization are separate and lack coherency. For example, designers generally start with a conceptual design, develop associated logic, perform synthesis of the logic design to develop an associated physical design, and analyze the physical design for timing performance. During these phases, designers may make adjustments to the one or more circuit devices, such as changing parameters of drive strength or making power optimizations. If the RTL design is not frozen, the designers may develop or change the logic, perform the synthesis to create another physical design, and analyze the new design. Until designs of the integrated circuits reach a “logic-freeze” stage, at which point synthesis stops, design improvements from physical optimizations are often lost for the iterations through the design flow. Such optimizations are often necessary for meeting design goals related to operating frequencies and power consumption.

Using a hardware design language (HDL), such as Verilog or VHDL (very-high speed integrated circuit HDL), is common. HDLs are advanced high order programming languages. HDLs require extensive knowledge and experience in programming techniques and languages. Requiring such knowledge and experience burdens VLSI hardware designers, requiring the designers to be familiar with advanced programming topics such as Object Oriented programming, Structured Programming, Strong Data Typing, and Component-based Design techniques. In most VLSI application specific (ASIC) designs, the algorithms to be implemented in VLSI hardware are initially developed in C, C++, or Java. The syntax of most HDL languages is different than C, C++ or Java. The difference of syntax requires the algorithms to be translated by the hardware designer into HDL. Current state of the art tools in HDL design entry are, for the most part, non-visual.

### BRIEF SUMMARY

Following are detailed descriptions of embodiments depicted in the accompanying drawings. The descriptions are in such detail as to clearly communicate various aspects of the embodiments. However, the amount of detail offered is not intended to limit the anticipated variations of embodiments. On the contrary, the intention is to cover all modifications, equivalents, and alternatives of the various embodiments as defined by the appended claims. The detailed descriptions below are designed to make such embodiments obvious to a person of ordinary skill in the art.

Some embodiments comprise enabling, via a GUI, selection of a logical function from a list, wherein the logical function is for a 1×N building block of an integrated circuit design. The embodiments also comprise enabling, via the GUI, selection of an implementation from a number of implementations of the logical function and automatically generating a 1×N building block representation of the logical function based on the selected implementation. The generated 1×N building block representation comprises a register transfer level (RTL) description of the 1×N building block.

Further embodiments comprise an apparatus having a GUI generator to generate a GUI for a display. The apparatus also comprises a logical function selector to select, via the GUI, a logical function from a number of logical functions for a 1×N building block of an integrated circuit design. The apparatus further comprises an implementation selector to select, also via the GUI, an implementation of the logical function. The implementation selector is configured to select the implementation from a number of implementations. The apparatus further comprises a 1×N building block representation generator to generate a 1×N building block representation of the 1×N building block based on the selected implementation.

Even further embodiments comprise a computer program product comprising a computer readable medium having a computer readable program, wherein the computer readable program causes the computer to enable selection of a logical function from a list via a GUI, wherein the logical function is for a 1×N building block of an integrated circuit design. The embodiments also enable selection of an implementation from a number of implementations of the logical function and generate a 1×N building block representation of the logical function based on the selected implementation.

### BRIEF DESCRIPTION OF THE SEVERAL VIEWS OF THE DRAWING

Aspects of the various embodiments will become apparent upon reading the following detailed description and upon reference to the accompanying drawings in which like references may indicate similar elements:

FIG. 1 depicts a computing system that may design integrated circuits using a closed-loop 1×N compiler, having a 1×N block builder and a 1×N GUI;

FIG. 2 is a flowchart illustrating different phases of a 1×N design process, including a 1×N compilation stage;

FIG. 3 illustrates design flow for a 1×N compilation for one or more embodiments;

FIG. 4A illustrates one embodiment of a closed-loop cycle between the elements of 1×N compilation and a logic phase;

FIG. 4B illustrates one embodiment of a closed-loop cycle between the elements of 1×N compilation and a synthesis phase;

FIG. 4C illustrates a process of automatically maintaining changes made to the 1×N building blocks during a physical design phase via mechanisms of back-annotation and reassembly;

FIG. 4D illustrates one embodiment of a closed-loop cycle between the elements of 1×N compilation and a timing analysis phase;

FIG. 5A shows one embodiment of a 1×N GUI window that a designer may use when creating or modifying 1×N building blocks;

FIG. 5B shows an alternative embodiment of a 1×N GUI window that a designer may use when creating or modifying 1×N building blocks;

FIGS. 6A-6B show different configurations of a 1×N building block that may be created via a 1×N GUI;

FIG. 7 depicts an apparatus having a 1×N block builder having a GUI generator, a logical function selector, and a 1×N building block representation generator; and

FIG. 8 shows a flowchart illustrating how a designer may create a 1×N building block for an integrated circuit design using a 1×N block builder.

### DETAILED DESCRIPTION

The following is a detailed description of novel embodiments depicted in the accompanying drawings. The embodiments are in such detail as to clearly communicate the subject matter. However, the amount of detail offered is not intended to limit anticipated variations of the described embodiments. To the contrary, the claims and detailed description are to cover all modifications, equivalents, and alternatives falling within the spirit and scope of the present teachings as defined by the appended claims. The detailed descriptions below are designed to make such embodiments understandable to a person having ordinary skill in the art.

Many of the embodiments contained herein describe using a 1×N GUI to create and/or modify 1×N building blocks when designing an integrated circuit. A circuit layout or circuit design may comprise a hierarchical collection of circuit elements or cells. A building block, or macro, may generally refer to the concept that a circuit may comprise a plurality of different circuit elements or cells, wherein the cells may be divided into categories. These categories may be basic cells, level cells, and building blocks. Basic cells, which may alternatively be referred to as leaf cells, may comprise an aggregation of circuit elements, such as a collection of logic gates, and may be thought of as residing at the bottom of the design hierarchy. Basic cells may be nested together, along with other circuit elements, to form level cells at different mid-levels within the design hierarchy. The level cells, which are frequently referred to as composition cells, may be further nested together to form building blocks, alternatively referred to as macros, which may also be referred to as root cells or prime cells. Building blocks may be thought of as residing at the top of the design hierarchy. Building blocks may also be referred to as blocks or modules.

1×N building blocks may contain a homogeneous collection of cells, also commonly referred to as bits, or contain an inhomogeneous collection of cells. For example, one 1×N building block may contain four AND gates while another 1×N building block may contain two AND gates, three NAND gates, and two OR gates, as well as auxiliary bits or cells. Additionally, while some bits of 1×N building blocks may be relatively simple, such as comprising a latch, some bits may also comprise a more complex collection of elements, such as comprising multiplexers.

The use of a cell at a specific level in the design hierarchy may be referred to as a cell instance, or instantiation. A circuit with only one hierarchical level is said to be flat. During a design sequence a VLSI design system may need to flatten a circuit design, converting the hierarchical levels into a single level, so that certain design tools may work with the design. For instance, a circuit simulation tool or a circuit optimization tool may only be able to simulate or optimize a circuit design that has a flattened netlist. A VLSI design system may flatten, or fully instantiate, a circuit design by recursively replacing all cell instances with basic circuit elements like resistors and capacitors.

Additionally, many of the embodiments use the term “optimized” and or “tuned”. As one skilled in the art of integrated circuit design will appreciate, such terms as “tuned”, “optimal”, and “optimized” as used in the design process may refer to a portion of an integrated circuit that has been altered to comply with some design constraint. For example, a simulation tool may determine drive strength for a specific gate in the circuit, selecting a parameter for the drive strength that makes a tradeoff between two or more competing interests, such as speed versus power consumption. Consequently, such terms should not be interpreted as choosing “optimal” or “best” settings, since such settings or parameters may often be subjective in nature. Such terms should therefore be considered in the context of integrated circuit design, consistent with the manner in which the terms are used by those possessing ordinary skill in the art.

Persons having ordinary skill in the art often use various titles for persons performing different tasks of creating an integrated circuit design. For example, some refer to a design engineer as a person that performs such tasks as receiving specifications, creating behavioral and logical circuit designs, running simulations, and evaluating prototypes that are fabricated. Similarly, some refer to a test engineer as a person that develops a test plan for a circuit design based on the specification and actually performs simulations of the design and/or physical tests of a fabricated prototype. Some may refer to a computer aided design (CAD) engineer as a person that uses CAD tools, such as schematic capture, simulation, synthesis, layout, and power estimation tools to evaluate and modify the circuit design. Due to the difference in use of titles, which may vary greatly, this specification uses the terms circuit designer, logic designer, or simply designer to refer to a person that may perform any of the described tasks for creating the circuit design. In other words, the terms circuit designer, logic designer, designer may be substituted interchangeably in the specification, and should not be interpreted as referring to a person that may only perform specific tasks. To the contrary, the terms circuit designer, logic designer, designer may refer to persons that can perform any of the tasks described herein, such as the tasks of behavioral design, logical design, physical design, and timing analysis/design.

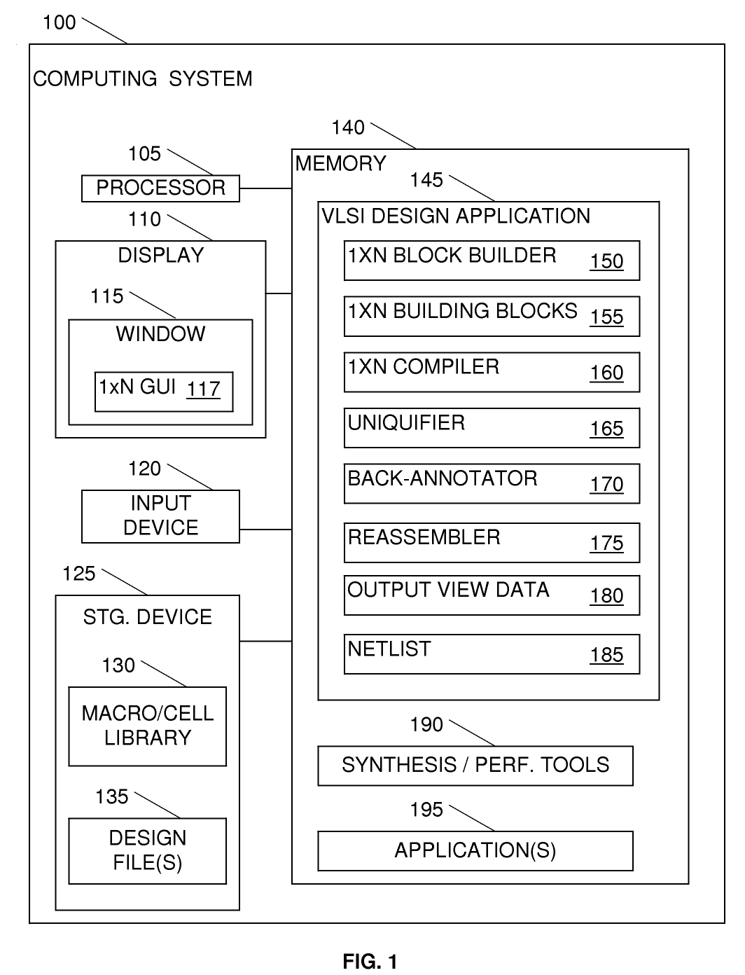

Turning now to the drawings, FIG. 1 illustrates a computing system 100 that may design integrated circuits using a closed-loop 1×N compiler 160. For example, computing system 100 may comprise a design workstation or a desktop computer executing a very-large-scale integration (VLSI) design application 145 in memory 140. A circuit designer may receive a specification for an integrated circuit (IC). Based on the specification, the circuit designer may define architecture for the IC and develop a circuit design for the IC at a very high level of abstraction. The circuit designer may then transfer the high-level circuit design to a physical designer. The physical designer may use computing system 100 and 1×N compiler 160 of VLSI design application 145 to convert the high-level circuit design into a very low-level circuit description, or tape out, which may be used to actually fabricate the IC.

1×N compiler 160 and VLSI design application 145 may provide a closed-loop environment that employs high-level 1×N constructs for tuning performance and power consumption. VLSI design application 145 may capture logic using both high-level RTL and references to 1×N building blocks. 1×N block builder 150 and 1×N compiler 160 of VLSI design application 145 may generate 1×N building blocks 155 via a high-level language and transform the 1×N building blocks into custom realizations using, e.g., building blocks available in a standard or custom cell library.

In various embodiments, a system may have a processor, such as processor 105, for executing program instructions of applications, such as VLSI design application 145. While executing program instructions of VLSI design application 145, computing system 100 may display images of the circuit design, or information pertaining to simulation or performance tuning, on a monitor or other computer display, such as display 1 10. For example, 1×N block builder 150 of VLSI design application 145 may generate a 1×N GUI 117 in a window 115 on display 110.

Using input device 120 a circuit designer may interact with VLSI design application 145. In one or more embodiments, input device 120 may comprise a keyboard and/or a mouse, allowing the circuit designer to perform such actions as viewing different circuit sections or performing numerous circuit design activities such as performing a timing analysis, increasing the drive strength of a gate, or defining which circuit elements should not be modified during various design cycle iterations. Input device 120 may also work in conjunction with 1×N GUI 117 and 1×N block builder 150. For example, the circuit designer may use input device 120 to make different selections from drop-down lists of 1×N GUI 117 and also modify HDL text generated by 1×N block builder 150 via the different selections.

In some embodiments input device 120 may comprise a tablet and stylus, such as a pressure-sensitive surface or a capacitance pad that recognizes hand-written characters and stylus movement. In even further embodiments input device 120 may comprise an audible input device, such as a microphone used for speech recognition. For example, in one embodiment input device 120 may allow a circuit designer to automate one or more tasks during the design flow, such as by recognizing when the circuit designer speaks the phrase “select a 2 port multiplexer to modify in the GUI”.

Display 110 and input device 120 may also allow the circuit designer to interact with VLSI design application 145 when creating, viewing, and manually modifying various 1×N building blocks 155. For example, 1×N block builder 150 may allow a circuit designer to retrieve a 1×N building block from a cell library 130, stored on a storage device 125. Storage device 125 may comprise a local solid state drive or a network hard drive, as examples, which stores standard cells and various instantiations created by a circuit designer. Upon retrieving a 1×N logic block, 1×N block builder 150 may allow a circuit designer to edit the 1×N building block by displaying configuration information for the 1×N building block in 1×N GUI 117 of window 115. After editing the 1×N building block via 1×N GUI 117, VLSI design application 145 may save the edited version back to cell library 130, a “Macfile”, and/or design files 135.

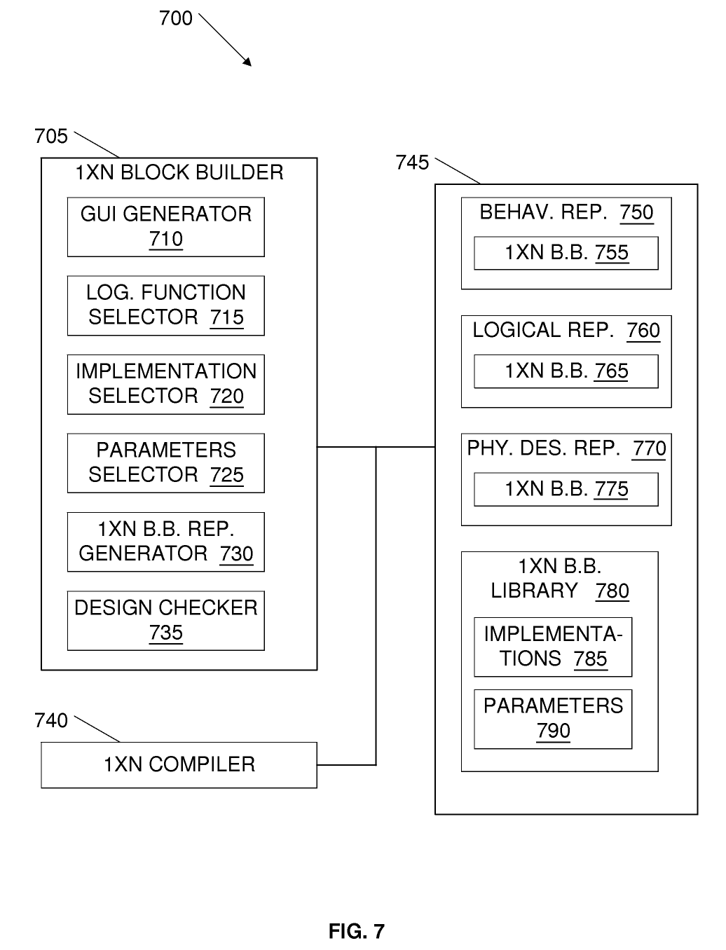

Worth noting, the term “Macfile” may be a file that stores information which defines one or more 1×N building blocks. As one having ordinary skill in the art will realize, alternative embodiments may store the 1×N building block definitions in one or more alternatively named files. The Macfile(s) may be used by the 1×N compiler when generating one or more representations of the integrated circuit design, such as behavioral representation 750, logical representation 760, and/or physical design representation 770 shown in FIG. 7.

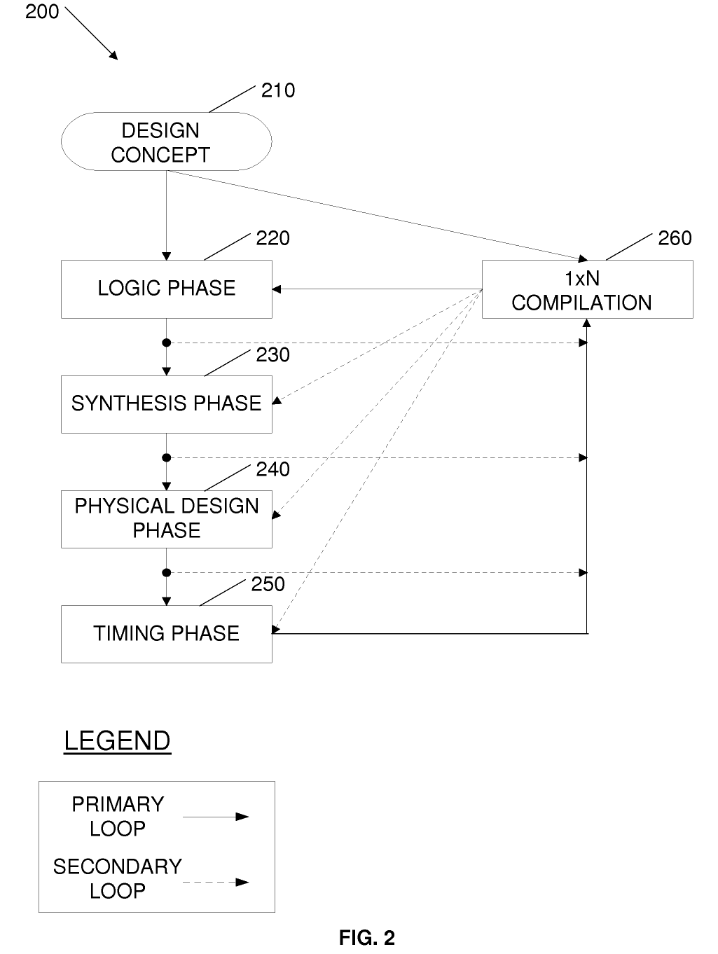

In the embodiment depicted in FIG. 1, VLSI design application 145 may design an IC using a closed-loop 1×N methodology, the specific details of which will be discussed later. However, to gain a general understanding of some of the steps that may be involved in the closed-loop 1×N methodology, as well as how this closed-loop methodology may differ from an open-loop design methodology, one may examine FIG. 2. FIG. 2 shows a flowchart 200 illustrating how a design for an IC may begin with a design concept 210.

The product of the design concept 210 may be a flowchart, a flow graph, or pseudocode. The designer may specify the overall functionality and input-to-output mappings without developing architectural or hardware details for the circuit design. Based on the design concept 210 the circuit designer may use a 1×N GUI, like 1×N GUI 117 generated via 1×N block builder 150, to develop 1×N building block descriptions for the circuit during logic phase 220, using a high-level language to define how the 1×N building blocks should work at a high level of abstraction. More specifically, the circuit designer may employ 1×N block builder 150 to generate a hardware description of the IC using a hardware description language (HDL), such as Verilog or VHDL. As is known to those skilled in the art, the high-level code or behavioral representation may be referred to as RTL netlists. At the RTL level, the behavioral description may consist of program-like constructs, such as, variables, operators, conditionals, loops, procedures and functions.

The circuit designer may then simulate the design, or different portions of the design, by using one or more behavioral tools to verify the design works as intended. For example, the circuit designer may apply input combinations and/or sequences of data to different modules to verify that the modules respond as intended. After the hardware description of the design has been through several iterations, and exhibits some degree of operability and stability, the circuit designer may convert the HDL code to a logical representation via a synthesis phase 230. During synthesis phase 230, a VLSI design application may convert the HDL definition of the circuit, transforming the textual descriptions of the behavioral representation to logic gates. In other words, the synthesis phase 230 may transform the VHDL code into a netlist describing the hardware, which may comprise circuit elements and the wires connecting them.

The logical representation may comprise gate-level logic, such as AND, OR, NOT, NAND, and NOR gates, to name just a few. The gate-level logic may be arranged to implement the desired functionality described in the high-level HDL code, which again may be automatically generated via for 1×N building blocks via 1×N GUI 117 and 1×N block builder 150. The tools that perform the conversion from the high-level description to the gate-level logic are generally called synthesis tools. For example, a set of synthesis programs from Synopsys® may perform the conversion from the high-level code to the logic-level code. As is known to those skilled in the art, the logical representation, or logic-level code, may be referred to as gate-level netlists. The logical representation may comprise a netlist of high-level macrocell components, such as adders, pipelined multipliers, arithmetic logic units, multiplexers, and register-files. Each macrocell, or building block, may have a corresponding netlist of primitive cells as well as a corresponding custom layout. This gate-level netlist of primitive cells and the layout may be generated using a silicon compiler tool, like 1×N compiler 160.

Once the high-level code is converted to gate-level code, the designer may perform additional testing via simulation and formal verification in order to verify that the gate-level netlists accurately represent the RTL netlists. In other words, one or more synthesis tools and/or behavioral tools may help the designer determine whether the logical design accurately represents what the behavioral design describes. If the logic-level code is successfully verified, a circuit designer may use one or more physical design tools to convert the logic level code into a detailed layout of structural components or elements of the circuit in physical design phase 240. The detailed layout of structural components may generally be referred to as a physical design representation. The physical design representation may comprise different forms and formats from embodiment to embodiment, as well as in the same embodiment. For example, persons having ordinary skill in the art may refer to different forms of the physical design representations using such terms as the physical realization, the hierarchical physical design (PD) netlist, the flattened netlist, the physical view, the physical placement data, the electrical realization, or simply netlist.

Two common forms of the physical design representations are the hierarchical PD netlist and the flattened netlist. As noted, the hierarchical PD netlist and the flattened netlist may represent the physical design produced during the physical design stage 240. Based on the physical design representation, the circuit designer may use one or more timing analysis tools during a timing phase 250 to evaluate the timing performance of the design. Assuming the timing performance is acceptable, the circuit designer may release the flattened netlist or the hierarchical netlist to a semiconductor fabrication facility to produce the IC.

The circuit designer may have to repeat one or more of the design activities numerous times before reaching the final physical design. For example, once the designer creates the gate-level logic in logic phase 220 and simulates the design via one or more simulation tools, the designer must often make changes to the HDL definition and create a modified version of the gate-level logic. Simulating the modified logic may uncover more design deficiencies that the circuit designer must correct. In other words, the circuit designer may have to pass through logic phase 220 numerous times.

Aside from logic changes, the circuit designer may also need to alter the design to correct problems encountered after synthesis phase 230, physical design phase 240, and timing phase 250. For example, the circuit designer may progress through the design process to the point where the design works perfectly under simulation, but finds that a routing tool cannot create a functional wiring arrangement for the design, due to rule restrictions or area constraints. Alternatively, one or more optimization tools may generate changes to the design. One such example may be incremental performance improvements, such as reduced delays, produced by iteratively feeding the results of a place and route (P&R) tool back into a synthesis tool.

During an open-loop design sequence, the circuit designer may need to exert caution to prevent having the accumulated design improvements altered or negated, due to disjointed activities of capturing logic in logic phase 220 and developing the physical design in physical design phase 240. Until the design reaches the logic-freeze stage, which halts subsequent synthesis in synthesis phase 230, physical optimizations such as tweaks made for drive strengths and power optimization may be lost during subsequent synthesis iterations. Using a closed-loop methodology offered by 1×N compilation 260, an application like VLSI design application 145 may maintain these physical optimizations without depending on disjointed tools and databases.

1×N compilation 260 may allow a VLSI design system to employ a closed-loop design process whereby physical implementation details, such as alterations due to drive strength and power optimization, may be fed back into each step of the design process. The VLSI design system may feed the design alterations back to the different design phases by using 1×N building blocks and inserting data generated by compiling the 1×N building blocks back into the design flow. For example, even after a flattened netlist of the design has been created and modified, 1×N compilation 260 may create an updated 1×N building block representation having numerous 1×N representations that may be modified or viewed via 1×N GUI 117 and 1×N block builder 150.

A VLSI design system may use a 1×N compiler during 1×N compilation 260 to create, modify, and maintain 1×N macros through the design process. As will be illustrated in the subsequent discussion of the various embodiments, the 1×N compiler may directly update the configuration file or files of a circuit design in a closed-loop manner. Additionally, the 1×N compiler may support direct wiring, have built-in design-for-manufacturability features, and have hierarchical wiring avoidance.

As FIG. 2 illustrates, the 1×N design methodology may involve a primary design loop and secondary design loops. The solid lines between design concept 210, logic phase 220, synthesis phase 230, physical design phase 240, timing phase 250, 1×N compilation 260, and back to logic phase 220 may represent the closed-loop nature of the primary design loop. The primary design loop shows the design flow through various stages of the design. Circuit designers may spend large quantities of time engaged in the various activities of the primary design loop, which may be characterized as the pre-logic-freeze design flow. In other words, the optimization decisions made in each phase of the methodology, such as synthesis phase 230, physical design phase 240, and timing phase 250, may be fed back into logic phase 220 via 1×N compilation 260 to iterate through the primary design loop again. Iterations through the primary design loop may involve changing 1×N building blocks and/or logical RTL structure. Each iteration or progression through the primary design loop may provide an improved starting seed for automated synthesis and optimization algorithms.

FIG. 2 also illustrates a number of smaller secondary design loops represented by the dashed lines. For example, one of the secondary design loops may comprise the loop defined by progressing from logic phase 220 to 1×N compilation 260, back to logic phase 220. Another secondary design loop may comprise the loop defined by progressing from 1×N compilation 260, to synthesis phase 230, to physical design phase 240, and back to 1×N compilation 260. The dashed lines may represent iterative changes through individual design phases and/or through iterative loops of multiple phases of the design, without necessarily progressing through the complete primary design loop. A 1×N design system may employ a closed-loop process to feed optimizations developed in a single design phase into another design phase without necessarily losing physical information.

With a general understanding of some of the steps that may be involved in the closed-loop 1×N methodology, we return now to FIG. 1. In various embodiments, a computing system like computing system 100 may execute a variety of different applications in addition to VLSI design application 145. For example, computing system 100 may execute a synthesis application and/or performance tuning tools 190. In one or more embodiments, tools 190 may represent a number of different applications comprising a tool suite. A circuit designer may use tools 190 to transform Verilog or VHDL code into a netlist describing the hardware for the physical design. A circuit designer may also use tools 190 to simulate the circuit design, perform timing analyses of the design, and generate a routing design for the circuit elements. In other words, tools 190 may comprise one or more applications that may work in conjunction with VLSI design application 145 and alter the circuit design as the circuit designer progresses through the various design stages, as illustrated in FIG. 2.

While FIG. 1 shows tools 190 to be separate from VLSI design application 145, in many embodiments one or more of the components of tools 190 may be integrated within VLSI design application 145. For example, VLSI design application 145 may perform synthesis actions and/or timing analysis functions without needing to resort to external applications. Additionally, in different embodiments, computing system 100 may execute one or more applications 195 that are unrelated to creating an integrated circuit design. For example, if computing system 100 comprises a workstation connected to the Internet, applications 195 may comprise a web browser application and an e-mail application. Alternatively, in embodiments where system 100 comprises a server, applications 195 may comprise a web server application or a database application.

Depending on the embodiment, computing system 100 may run a variety of different operating systems. For example, in one embodiment computing system 100 may use AIX®. In another embodiment, computing system may use Microsoft® Windows®, Linux®, or Mac OS®, as examples. Other alternative embodiments may have no operating system at all. For example, computing system 100 may comprise a state machine or microcontroller executing firmware instructions, such that no operating system is necessary.

One or more design files 135 may be stored on a storage medium of storage device 125 and accessed by computing system 100. For example, storage device 125 may comprise one or more of a variety of different mass storage devices used to store VLSI design files 135 and macro and/or cell library 130. For example storage device 125 may comprise a serial hard disk drive or a small computer system interface (SCSI) redundant array of inexpensive disks (RAID). Alternatively, storage device 125 may also comprise an optical storage device, such as a rewritable compact disc (CD) or a digital versatile disc (DVD) drive, having storage mediums of a CD and DVD, respectively. In other embodiments, storage device 125 may comprise a flash memory device, such as a universal serial bus (USB) drive. Storage device 125 may also store other files and information, such as the operating system for computer system 100.

While not shown in FIG. 1, alternative embodiments of a computing device in a system may connect to other computers of the system using a variety of different hardware. For example, computing system 100 may comprise a CAD workstation computer connected to another computer via a wireless communications card, or an Ethernet cable coupled to a local or wide area network (LAN or WAN). The desktop computer may, e.g., download and import cell files and/or 1×N building blocks from the Internet.

In one or more alternative embodiments, computing system 100 may also work with one or more other networked computing devices to perform one or more of the different design activities. For example, in one embodiment a designer may use 1×N GUI 117, 1×N block builder 150, and 1×N compiler 160 of computing system 100 to edit and compile 1×N building blocks and generate a schematic view for the IC design. However, during the synthesis, physical design, or timing analysis stages, VLSI design application 145 may transfer netlist 185 for the design to the networked computer(s). Such an arrangement may be desired, for example, where the design task requires extensive computational power that may otherwise overload computing system 100. As the above example illustrates, various embodiments of a system may comprise an almost limitless number of wired and wireless communication devices, allowing computing devices of a system to communicate with each other to share and/or process VLSI design files, wherein the computers may be located close to or remote from each other.

As described earlier, 1×N block builder 150 of VLSI design application 145 may be used to create, view, and/or edit 1×N building blocks 155. 1×N building blocks 155 may comprise the means by which physical implementation details of circuit elements in 1×N building blocks 155 are stored. A building block of 1×N building blocks 155 may provide a layer of abstraction between the logical behavior of the block and the physical realization of the corresponding logic elements. In numerous embodiments, 1×N building blocks 155 may comprise one or more user-configurable text files. The user-configurable text files may be created and edited via 1×N block builder 150 and 1×N GUI 117. In alternative embodiments, the building blocks may be represented in an alternative file format. For example, the building blocks may be stored in a proprietary binary file that is encoded and decoded as a circuit designer views/edits the 1×N building blocks.

1×N compiler 160 may perform a variety of tasks in VLSI design application 145. 1×N compiler 160 may comprise a software module or other type of module that, at a high level of abstraction, converts data from the building blocks of 1×N building blocks 155 into behavioral, physical, and logical representations, or definitions. 1×N compiler 160 may convert 1×N building blocks 155 into specifically formatted implementations as required by the different design phases. For example, conversions of 1×N building blocks 155 may be represented by 1×N compilation 260 in FIG. 2. During 1×N compilation 260, 1×N compiler 160 may take 1×N building blocks 155 generated by physical design 240 and reformat 1×N building blocks 155 into a form compatible with logic stage 220, without losing physical information that may have been generated in previous design iterations. Similarly, during 1×N compilation 260, 1×N compiler 160 may take 1×N building blocks 155 generated by logic phase 220, synthesis phase 230, or timing phase 250 and reformat 1×N building blocks 155 into a form or forms compatible with each of the phases, without losing physical, behavioral, or logical information that may have been generated in previous design iterations.

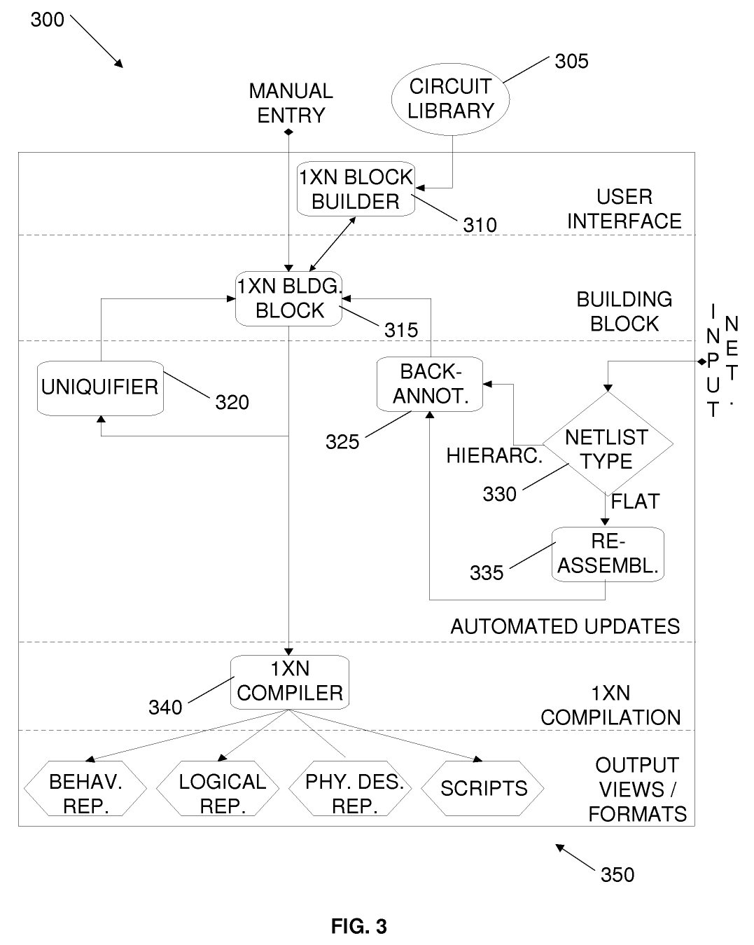

FIG. 3 depicts a flowchart 300 that illustrates a design flow of a 1×N compilation for one or more embodiments. FIG. 3 illustrates how a circuit designer may use a 1×N block builder 310 to retrieve and edit one or more building blocks from a circuit library 305. For example, 1×N building block 315 may comprise a specific instantiation of 1×N building blocks 155 retrieved from cell library 130 and loaded into 1×N block builder 150.

1×N block builder 310 may comprise or work in conjunction with a GUI routine that allows the circuit designer to create one or more building blocks and implement a desired logical function. For example, 1×N block builder 310 may comprise 1×N block builder 150 and 1×N GUI 117, which may allow the circuit designer to create a bank of NAND logic gates in a relatively easy and efficient manner without having to be familiar with the actual scripting language required by 1×N compiler 160. 1×N building block 315 may represent a 1×N building block of 1×N building blocks 155. For example, in one or more embodiments 1×N building block 315 may comprise a file-based representation of a 1×N building block. The 1×N building block representation may comprise one or more text files, and/or one or more binary files, that store information defining the functions and interconnections or the 1×N building block. As FIG. 3 illustrates, 1×N compiler 340 may compile the representation(s) of 1×N building block 315 to create the different views 350. Also as FIG. 3 illustrates, 1×N building block 310 may use elements of circuit library 305 when creating and/or editing 1×N building block 315. A circuit designer may also use 1×N building block 310 to edit, modify, and/or view existing 1×N building blocks.

In various embodiments, 1×N block builder 310 may comprise the initial entry point to the 1×N compilation stage, which may correspond to 1×N compilation 260 shown in FIG. 2. 1×N block builder 310 may provide a layer of abstraction between the complexity of the physical elements comprising 1×N building block 315 and the associated logical representation. 1×N block builder 310 may check design requirements for each logical function and generate or create 1×N building block 315 that provides the proper gate constructs. 1×N block builder 310 may check the design requirements and create 1×N building block 315 without requiring the circuit designer to intervene or potentially even understand the design requirements.

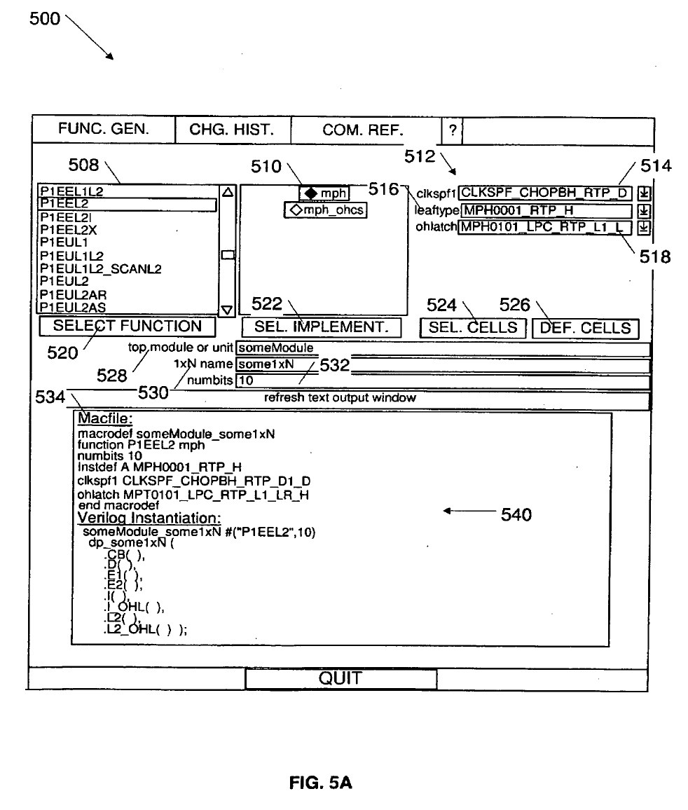

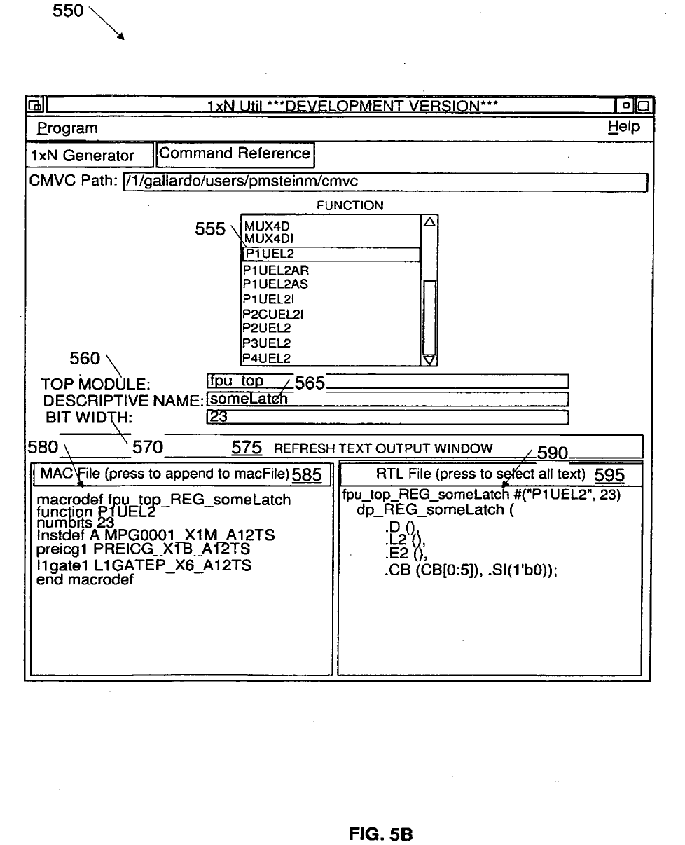

While 1×N block builder 310 may generate a default set of implementation details, the designer may be able to choose between specific implementation types and make specific customizations for 1×N building block 315, such as specific drive strengths, Vt-hybridizations, and/or voltage island references. Once the designer has chosen a desired 1×N building block 315 to build, 1×N block builder 310 may generate a logical RTL instantiation for 1×N building block 315, as well as work in conjunction with 1×N compiler 340 to generate a physically realizable form of 1×N building block 315. Embodiments of 1×N GUIs for block builder 310 are depicted in FIGS. 5A and 5B.

FIG. 5A shows one embodiment of a 1×N GUI window 500 that a designer may use when creating or modifying 1×N building blocks. FIG. 5A illustrates an example 1×N GUI that a 1×N block builder, such as 1×N block builder 150, may generate and display in window 500 enabling a circuit designer to make numerous selections. FIG. 5A also shows that the circuit designer has chosen to create an implementation of a logical function, wherein the logical function is a single-port, non-inverting latch bank with clock enable. A 1×N block builder may present a list of logical functions to a circuit designer, via window 500. For example, 1×N block builder may obtain numerous logical functions for 1×N building blocks from a circuit library like cell library 130 and list the logical functions in list-box 508. Other logical functions may comprise items such as an AND bank, an OR bank, a two-port multiplexer, or a three-bit latch, as just a few examples.

The circuit designer selected the non-inverting latch bank from list-box 508. Based on the selection of the non-inverting latch bank with clock enable, the circuit designer may click on the select function pushbutton 520 to have the 1×N block builder update the choices for implementation selections and present two implementations of the non-inverting latch bank for the circuit designer to choose from in top-middle section 510. As window 500 shows, the 1×N block builder has presented one implementation with a separate overhead clock splitter (mph ohcs) and one without a separate overhead clock splitter (mph). In this example, the designer has selected the implementation without a separate overhead clock splitter.

The drop-down lists 512 on the top-right of FIG. 5A illustrate how the 1×N block builder may update parameter selections and present the parameters to the circuit designer, enabling the circuit designer to further tweak the design for the functional implementation of the selected non-inverting latch bank. The 1×N block builder may update the parameter selections after the circuit designer clicks the select implementation pushbutton 522. Using a hierarchical scheme for list-box 508, section 510, and drop-down lists 512, the top-most drop-down list 514 may contain a plethora of clock splitter choices including, but not limited to drive-strength, Vt-hybridization, orientation, and specific clocking implementation. The middle drop-down list 516 may also contain a plethora of choices for the latch type, including, but not limited to drive-strength, Vt-hybridization, and orientation. The bottom drop-down list 518 may also contain a plethora of choices for the overhead latch type, including, but not limited to drive-strength, Vt-hybridization, and orientation.

Depending on the embodiment, the 1×N GUI may allow the circuit designer to simply select a default selection of tuning parameters and/or cell parameters via a default cells pushbutton 526. For example, once the circuit designer selects the implementation by clicking select implementation pushbutton 522, the circuit designer may click default cells pushbutton 526. Clicking the default cells pushbutton 526 may grey-out the drop-down lists and prevent the circuit designer from accidentally changing the selections and select the default selections for all of the drop-down lists 512. Alternatively, the circuit designer may click the select cells pushbutton 524 which will enable the designer to choose from the different selection choices from each of the drop-down lists of drop-down lists 512.

As one skilled in the art will appreciate, the methods of selecting the parameters may vary from embodiment to embodiment, the aforementioned configurations representing just a few embodiments. Other embodiments may behave differently. For example, in an alternative embodiment select cells pushbutton 524 and default cells pushbutton 526 may not alter the selections available via drop-down lists 512. Instead, clicking the default cells pushbutton 526 may simply cause the default parameter selections to be generated for the 1×N building block, regardless of the selections shown in the drop-down lists 512. Clicking the select cells pushbutton 524 may cause the selections shown in the drop-down lists 512 to be generated for the 1×N building block.

A 1×N block builder and associated 1×N GUI may use the framework described above to enable correct-by-construction integration. The parameter selections updated and presented to the circuit designer via drop-down list 514, drop-down list 516, and drop-down list 518 may depend on both the logic function selected from list-box 508 and the specific implementation selected from section 510. In other words, the hierarchical scheme implemented by the 1×N block builder may present different implementation selections based on the particular logical function selected, and different parameter selections based on particular implementation that is selected. Thus, the choices made in each section may help steer the circuit designer toward a physically realizable 1×N building block instead of allowing the designer to make choices from any circuit or logical implementation available in the circuit library, many of which are likely to be physically unrealizable. The selections or choices available to the circuit designer may depend on the configuration available to the VLSI design system, such as the configurations of the logical functions for the 1×N building blocks in cell library 130. Additionally, one may note that the 1×N block builder and the 1×N GUI may be configured to select default values from any list instead of waiting for designer input to populate each section.

Note that the embodiment depicted in FIG. 5A required the user to click or otherwise activate pushbuttons in order to have the 1×N block builder to update the implementation selections and the parameter selections. Other embodiments may behave differently, such as automatically updating the selections after the circuit designer makes the selections with a single mouse-click. Additionally, the 1×N GUI may differ in different embodiments, such as by using a drop-down list instead of list-box 508 to present the different logical functions, or using all list-boxes for each of the selection categories. Even further, the manner of making the selections may differ in alternative embodiments. For example, one embodiment may require the circuit designer to make selections via radio buttons, check-boxes, or other types of GUI selection techniques.

The 1×N block builder may also enable a circuit designer to input or enter a name for the 1×N building block. For example, the embodiment of FIG. 5A illustrates that the 1×N block builder may require a two-part name for the 1×N building block, comprising a unit name 528 and a 1×N name 530. Alternative embodiments may enable other naming conventions, such as a single-part name or other multiple-part name. Further, the 1×N block builder may enable the circuit designer to select or enter the number of bits, or individual cells of the 1×N building block, via numbits 532.

Once the circuit designer has made various selections for the logical function, the implementation, and the parameters for the 1×N building block being created or edited, the 1×N block builder may generate corresponding text, comprising the RTL or 1×N building block representation, for the 1×N building block in text output window 534. In some embodiments, the 1×N block builder may enable the circuit designer to edit the text of the 1×N building block representation manually, allowing even greater flexibility and customization of the 1×N building block. In the embodiment of FIG. 5A, this text may be referred to as a “Macfile” and the associated Verilog instantiation for the 1×N building block of the Macfile. A circuit design may have many Macfiles and many 1×N building blocks. For example, a design may comprise fifty Macfiles, wherein the fifty Macfiles collectively correspond to thousands of 1×N building blocks. Depending on the embodiment, the Macfiles or the design files may be updated in different ways. For example, in one embodiment, the circuit designer may cut and paste the generated text into the respective Macfiles and/or design files. In other embodiments, the 1×N block builder may automatically cut and paste the 1×N building block representation, or otherwise enter the 1×N building block representation into the respective Macfiles and/or design files, upon request of the circuit designer.

Various embodiments may cause the 1×N block builder to generate the 1×N building block representation in different manners. For example, one embodiment may not generate the 1×N building block representation or otherwise populate any portion of text output window 534 until the circuit designer clicks the individual pushbuttons. Some embodiments may not generate any of the 1×N building block representation until the circuit designer has clicked one pushbutton for each of the selection categories. Even further embodiments may dynamically generate and update the 1×N building block representation as the circuit designer makes the various selections. For example, if the circuit design makes one selection for a specific implementation but changes his mind and selects another implementation, the 1×N block builder may delete and replace the appropriate sections of the 1×N building block representation in text output window 534 accordingly. In numerous embodiments, the 1×N building block may be configured to not change the Verilog instantiation as long as the function type and number of bits remains unchanged, even though the circuit designer may continually tune the specifics of the 1×N enclosed in the 1×N building block.

FIG. 5B shows an alternative embodiment of a GUI window 550 that a circuit designer may use when creating or modifying 1×N building blocks. As FIG. 5B illustrates, alternative embodiments may simplify the 1×N block building process via a more simple interface. The 1×N block builder for window 500 may provide a list-box 555, enabling the circuit designer to select a particular logical function for the 1×N building block. The 1×N block builder may also enable the circuit designer to enter a name and a number of bits for the 1×N building block via text input ports 560, 565, and 570.

As the circuit designer selects logical functions via list-box 555 and/or makes changes to the text input ports 560, 565, and 570, the circuit designer may click the refresh pushbutton 575 to cause the 1×N block builder to update the text in Macfile window 580 and RTL file window 590. Once the 1×N block builder refreshes or updates the texts of the respective windows, the circuit designer may click the Macfile append pushbutton 585 to have the 1×N block builder append the Macfile text to the appropriate Macfile and click the RTL file pushbutton 595 to copy the RTL text to a clipboard which may enable the circuit designer to paste the RTL text to the appropriate design file.

The 1×N block builder may be extendable, meaning a desired logical function or implementation can be added to the list of logical functions if the desired logical function is not available. Similarly, where a circuit library is expanded to allow for different selections of implementations, drive-strengths, or Vt choices, the 1×N block builder lists may be updated on-the-fly to make use of the different selections.

One benefit of using a 1×N block builder as an initial entry point to the 1×N compilation stage may be that the 1×N block builder provides a layer of abstraction between the complexity of the physical 1×N building block and the corresponding logical representation. The 1×N block builder may be configured to check design requirements, such as physical design requirements, for each logical function and generate a 1×N building block which provides the proper gate constructs (physically realizable) -without requiring the circuit designer to intervene or even understand the requirements. For example, if the circuit designer chooses to implement a standard, single-port latch with enable, the 1×N block builder may generate the 1×N building block representation for a 1×N building block that describes the proper latch, clock splitter and overhead latch combinations for that logical function as well as the associated connectivity. A 1×N block builder may make use of a set of functional and physical requirements to create customizable 1×N building blocks on-the-fly, within the confines of a design database. Creating customizable 1×N building blocks on-the-fly may be advantageous, as all the design attributes may be retained in single repository.

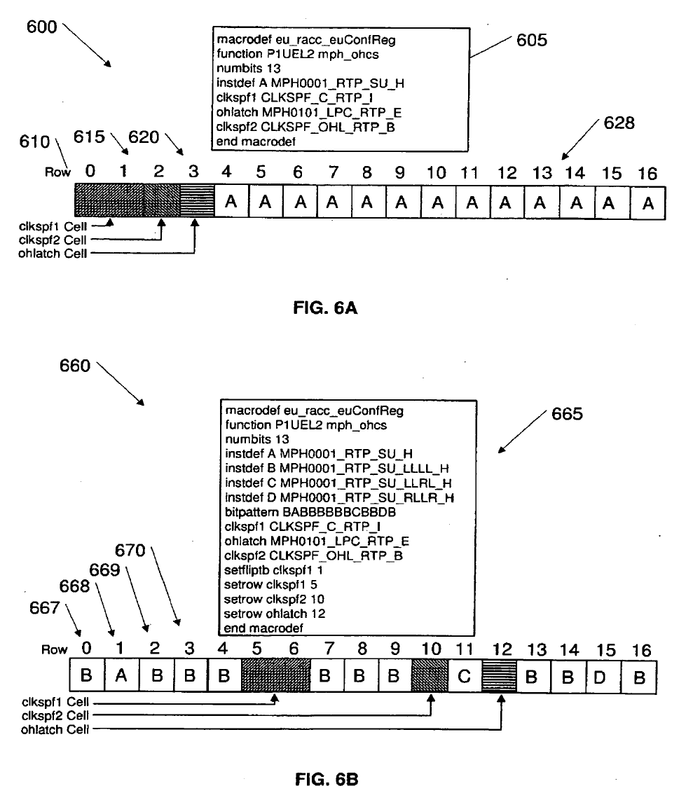

A 1×N block builder may generate window 500 on display 110 when a circuit designer edits a specific building block, such as illustrative 1×N building block 600 depicted in FIG. 6A. As FIG. 6A illustrates, 1×N building blocks may include a physical tiling methodology to create a row 610 of duplicate or similar cells, one or more overhead or support cells, as well as associated interconnectivity that matches the logic specification for the cells. For example, one 1×N building block may comprise a number of NAND gates, various parameters for one or more of the individual gates, two support cells, and some interconnection data. Another 1×N building block may comprise a row of multiplexers and support cells. As one skilled in the art will realize, the type of common cell for a 1×N building block, as well as the number of support cells and parameters, may vary greatly from building block to building block. The examples cited above and elsewhere in the specification are only a few examples cited for the sake of illustration. One should not interpret that 1×N building blocks are limited to the cited configurations. On the contrary, the different configurations or arrangements of cells and parameters for different 1×N building blocks are innumerable.

Compiling 1×N building blocks like 1×N building block 600 with a 1×N compiler may enable a VLSI design application to perform numerous transformations, or modifications, to elements and/or cells in the building blocks during the design process. The VLSI design application or a designer may invoke timing optimizations and/or power optimizations, either directly through synthesis refinement or manually via engineering change (EC) mode. The designer or VLSI design application may change predefined 1×N building blocks. For example, the designer may transform such parameters as polarity, drive strength, and hybrid-Vt for 1×N building blocks, thereby creating custom 1×N building blocks.

Using a 1×N compiler within a 1×N building block methodology to design a VLSI circuit may create a framework that allows 1×N building blocks to be utilized in different ways. For example, in some embodiments, 1×N building blocks may be configured for use with industry-standard formats. In other embodiments, the 1×N compiler may allow the 1×N building blocks to use alternative, special, or proprietary features. As will be illustrated, the 1×N compiler may have the ability to “reform” or reassemble hierarchy from a previously flattened hierarchical design, allowing optimization tools that work on flat data to nonetheless enable use of 1×N building blocks.

FIG. 6A depicts what may comprise a fully-realizable 1×N building block 600 in an embodiment. 1×N building block 600 may comprise a single-port, non-inverting latch bank with clock enable based on designer input from 1×N block builder 310. Alternatively, 1×N building block 600 may comprise a default implementation of a 1×N building block. FIG. 6A shows a single latch type (A) arranged in rows 4-16 (element 628) with two clock splitters (element 615) arranged in rows 0-1 and 2, and an overhead latch (element 620) in row 3. FIG. 6A also depicts the associated logical RTL 605 generated by the 1×N block builder for 1×N building block 600.

FIG. 6B shows another customized 1×N building block 660 corresponding to 1×N building block 600 illustrated in FIG. 6A. FIG. 6B further illustrates the flexibility of a 1×N Building Block. 1×N building block 660 has four different Vt-hybridization choices 665, represented by “instdef A” through “instdef D”, for the latch bits and the physical placement data for each cell in 1×N building block 660. As FIG. 6B illustrates, the latch bits are staggered in rows 0-4, 7-9, 11, and 13-16 with each Vt-hybridization choice represented by a different letter. The two clock splitters are staggered in rows 5-6 and 10 with the overhead latch arranged in row 12.

1×N building blocks 600 and 660 are exemplary building blocks, none of which may be required in any specific embodiment. 1×N building blocks 600 and 660 may be the results of individual optimizations through each design phase in order to meet power, area, and timing goals for one particular latch bank and the associated timing paths for the latch bank. Various integrated circuit parameters may vary with factors such as temperature, voltage and frequency. One circuit parameter that a circuit designer may adjust is the drive strength of one or more circuit devices, such as an output driver stage. For example, the circuit designer may match the output drive strength of a signal to the circuit being driven. Another parameter that a circuit designer may adjust is Vt-hybridization. Vt-hybridization refers to an optimization technique for static power reduction while optimizing performance within a given drive strength. Worth emphasizing, in many embodiments the polarity of individual bits of a 1×N building block may also be modified by optimization routines. Additionally, the polarity of individual bits may be manually modified.

Returning back to FIG. 3, uniquifier 320 may comprise a software module or other type of module that permits individual building blocks 315, which may correspond to individual building blocks of 1×N building blocks 155 of FIG. 1, to be reused within a design. When a designer decides to reuse a 1×N building block, at a particular step in the design phase, the designer may designate a parent definition and a number of child definitions for that 1×N building block. In other words, uniquifier 320 may create a type of software inheritance, wherein each child definition may inherit the properties of the related parent definition, unless the inheritance is overridden. For example, uniquifier 165 may work in conjunction with 1×N compiler 160 during the 1×N compilation stage, read a netlist 185, read the current set of building blocks of 1×N building blocks 155, and determine whether any building blocks are reused. If any building blocks are reused, uniquifier 165 may create parent-child definitions where such definitions do not already exist and produce a new netlist 185 with unique names for each child that directly corresponds to the child definitions created with the building block definitions.

In some embodiments, uniquifier 320 may also be configured to selectively ignore or uniquify specific sets of 1×N building blocks 315. Selective uniquification of building blocks may be advantageous in situations where parent-child relationships do not need to be defined during the logic entry stage, which may correspond to logic phase 220. The parent-child relationships may be defined on-the-fly as the relationships are required for a design stage. Depending on the embodiment, uniquifier 320 may be configured to read netlist 330 in a mixture of different formats. For an example referring to FIG. 1 and FIG. 2, uniquifier 165 may read netlist 185 formatted in one format generated in physical design phase 240, yet also read a modified version of netlist 185 formatted in a second format generated after tuning from timing phase 250.

During the various iterations of a design, 1×N compiler 340 may generate compilation data for a number of different views 350. The different views of views 350, which may correspond to output view data 180 depicted in FIG. 1, may comprise behavioral representations, gate-level or logical representations, physical design representations, and an output view for various types of scripts.

1×N compiler 340 may generate compilation data for behavioral RTL as well as gate-level RTL. Additionally, 1×N compiler 160 may generate compilation data for physical views, helper scripts, and potentially numerous other views depending on the embodiment. For example, VLSI design application 145 may use 1×N compiler 160 to generate Verilog HDL behavioral RTL and corresponding Cadence™ physical views. Additionally, in numerous embodiments, 1×N compiler 160 may be configured based on the tool suite of the user, such as tools 190. In other words, an embodiment may control which languages and view types are generated. An alternative embodiment may generate VHDL behavioral RTL and corresponding Synopsys® physical views.

### Iterative Logic Cycle

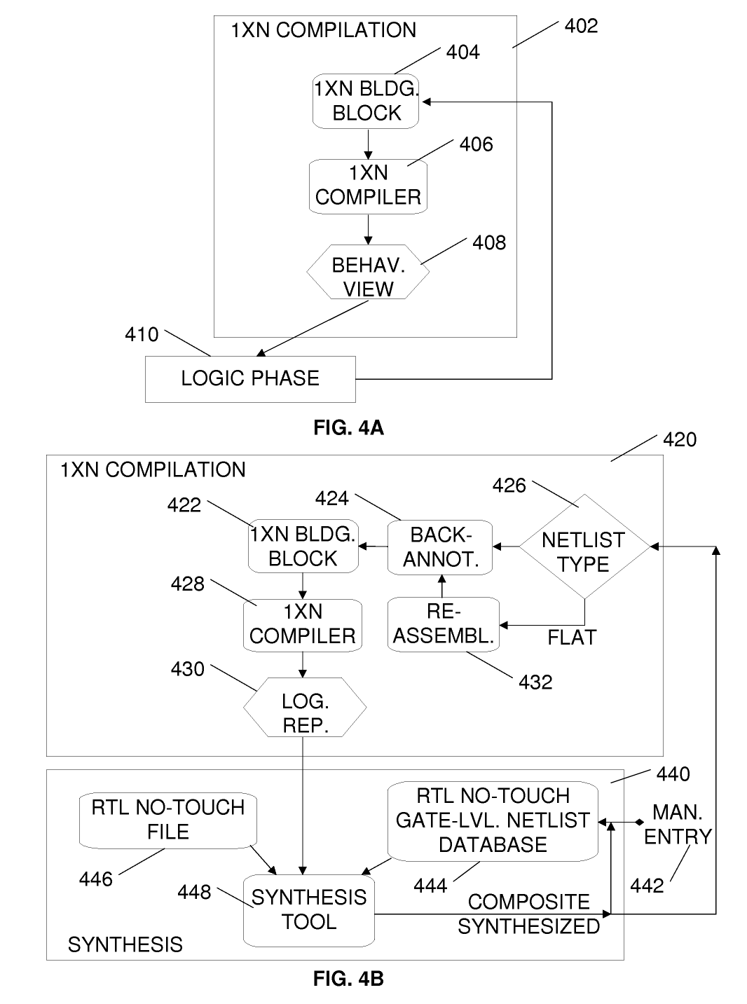

To illustrate in more detail the iterative logic, synthesis, physical design, and timing cycles for 1×N building blocks, we turn now to FIGS. 4A-4D. For the sake of illustrative context, logic phase 410 and 1×N compilation 402 of FIG. 4A may correspond to logic phase 220 and 1×N compilation 260 shown in FIG. 2, respectively. The closed loop may comprise the design flow from logic stage 220 to 1×N compilation 260, via the secondary/dashed flow line, and back from 1×N compilation 260 to logic stage 220, via the solid/primary flow line. Additionally, 1×N building block 404 and 1×N compiler 406 may correspond to 1×N building block 315 and 1×N compiler 340, respectively, of FIG. 3.

FIG. 4A illustrates one embodiment of a closed-loop cycle between the elements of 1×N compilation 402 and logic phase 410. For example, during a design of an integrated circuit, a circuit designer may have created the behavioral RTL, synthesized the RTL and converted the design from a behavioral script form to a physical design form, and tuned or optimized the flattened form of the physical design to meet certain performance requirements. The circuit designer may then take the flattened physical design altered during a timing analysis and view/modify the behavioral definition of the design at logic phase 410. In other words, the designer may generate a behavioral view 408 from the flattened physical design via 1×N compilation 402. Behavioral view 408 may comprise, e.g., a VHDL listing for the design. Worth pointing out, the entry point into 1×N compilation 402 to generate behavioral view 408 may be from one of the other stages, not just logic stage 410 as depicted in FIG. 4A. As described in the example, the entry point into 1×N compilation 402 was from the timing stage, such as from timing phase 250 as illustrated in FIG. 2.

The iterative logic cycle depicted in FIG. 4A may enable more liberal logic reuse by increasing the level of abstraction for the gate-level design by using 1×N building blocks, such as 1×N building block 404. The use of 1×N building blocks may enable the increase of logic reuse as a result of decoupling the gate-level implementation of a 1×N building block from its logical function via the use of the 1×N compiler. To illustrate the increase of abstraction and the decoupling of the gate-level implementation from the logical function, we may briefly return to FIG. 5A. As shown in FIG. 5A, an RTL instantiation of a 1×N building block may include parameterized calls 540 that describe features of 1×N building blocks. For example, the 1×N building block features may include a logical function type and a number of bits for the 1×N building block. Logical function types and numbers of bits are just example features; other features may be available in various alternative embodiments.

1×N compiler 406 may insert checks, or verification text, in the 1×N behavioral RTL model for the parameterized features. When the design is simulated via an RTL simulation tool, the verification text may ensure that the intent of the designer, which is described in the RTL, matches the gate-level implementation defined by the 1×N behavioral model. One should note that the behavioral model for a 1×N building block may not need to be gate-specific. As a behavioral model, the model may describe the logical function using higher-level constructs. The higher-level constructs may be defined by the RTL language used. For example, the higher-level constructs for System Verilog may be different than the higher-level constructs for VHDL.

1×N compiler 406 may verify that the behavioral model, which may be represented by behavioral view 408, and the gate-level implementation are equivalent. For example, in one embodiment 1×N compiler 406 may verify that the behavioral model and the gate-level implementation are equivalent by using one or more verification tools. The verification tools may be, e.g., industry standard verification tools available in IC design systems available from Cadence™, Synopsys®, Mentor Graphics®, Magma®, or other design systems. Verifying the equivalency of the behavioral model and the gate-level implementation may help protect the designer from inadvertent changes during the logic design, as well as protect the designer from gate-level changes that might alter a function of a 1×N building block.

The behavioral model construct generated by 1×N compiler 406 may allow the circuit designer to reuse 1×N building block 404 and related logical function(s) in the design without having to worry about the gate-level tweaks that may be necessary for proper placement or timing of the specific 1×N building block. Consequently, using the generated behavioral model may also help protect the intellectual property described in the gate-level netlist because the gate-level details are not directly disclosed by the RTL listing. In other words, a hardened or physically-realized design that uses this 1×N building block methodology may be converted to a softened, or RTL-level, design and transferred to another party with less risk of exposing physical details, which may be sensitive or proprietary in nature. Generating an RTL-level design from a physically-realized design may not necessarily be limited to 1×N building blocks. 1×N compiler 406 may generate an RTL-level design from other types of hierarchical RTL elements. In other words, the 1×N methodology described herein may provide an automated closed-loop approach that may used to create RTL-level or behavioral-level design for numerous other RTL elements.

### Iterative Synthesis Cycle

To illustrate in more detail the iterative synthesis cycle, we move to FIG. 4B. Synthesis phase 440 and 1×N compilation 420 of FIG. 4B may correspond to synthesis phase 230 and 1×N compilation 260, respectively, shown in FIG. 2. The closed loop may comprise the design flow from synthesis phase 230 to 1×N compilation 260, via the secondary/dashed flow line exiting synthesis phase 230, and back from 1×N compilation 260 to synthesis phase 230, via the secondary/dashed flow line between the two. Additionally, internal elements of 1×N compilation 420 may correspond to the respective elements depicted in flowchart 300 for FIG. 3.

FIG. 4B illustrates one embodiment of a closed-loop cycle between the elements of 1×N compilation 420 and synthesis phase 440. Synthesis phase 440 may comprise a stage in the design process where a design application like VLSI design application 145 may use 1×N compiler 160 to perform a substantial number of automated optimizations. In the classical design methodology, many of the updates created by the automated optimization tools are discarded prior to logic-freeze, because the physical information for these updates is not translated back to the RTL. To help prevent the loss of one or more of the optimization updates, the 1×N building blocks and the 1×N compiler may provide an “RTL no-touch” feature.

The RTL no-touch feature may comprise a software routine of a VLSI design application. For example, RTL no-touch software may comprise a set of instructions that guides a synthesis engine, such as synthesis tool 448, preventing the engine from synthesizing a set of RTL statements. Preventing the synthesis engine from synthesizing a set of RTL statements may be helpful when the RTL for a specific section of a design has already been optimized. For example, the RTL for two sections of a design may have been optimized by some tool or by human intervention. The designer may want the two sections to remain unaltered in subsequent iterations of the synthesis engine. One may contrast the RTL no-touch feature with conventional approaches, where the synthesis engine of the conventional approaches would integrate the gate-level entities within the RTL, alter the generic nature of the RTL, and make the design technology dependent.

Various embodiments may provide an RTL no-touch feature by allowing specific sets of RTL constructs to be designated as having been previously implemented and optimized as gate-level netlists. For example, a circuit design may have twenty-five different 1×N building blocks. A circuit designer may have synthesized the circuit and tuned a portion of the circuit having ten 1×N building blocks. The circuit designer may want to add some additional circuit functions, or otherwise modify the circuit design at the behavioral level, using Verilog HDL. The circuit designer may designate the ten 1×N building blocks that have been tuned as no-touch blocks. As a consequence, any subsequent automated optimizations performed on the circuit design may tune or alter the other fifteen 1×N building blocks and the newly added circuit functions but make no more tuning or optimization changes to the ten previously tuned building blocks.

Various embodiments may implement the RTL no-touch feature by maintaining the gate-level netlists for the no-touch building blocks (element 444) separate from the behavioral level design. The embodiments may maintain separate gate-level netlists and behavioral lists to the building blocks as long as both the gate-level netlists and behavioral lists are proven and maintained to be logically equivalent, such as by using industry-available tools. The RTL no-touch feature may not be limited to 1×N building blocks. Many embodiments may implement the RTL no-touch feature for both 1×N building blocks and other types of hierarchical cells and circuit elements in a circuit design. Using the RTL no-touch feature for other types of circuit elements may allow a designer to tune one or more parts of a circuit design, which may contain both 1×N building blocks and non-1×N elements, and prevent such tuning parameters from being erased or overwritten during subsequent tuning or optimization for other portions of the circuit design. Referring to FIG. 2, the designer may designate numerous elements as no-touch elements in synthesis phase 230, wherein the no-touch elements may remain unaltered in subsequent iterations of logic phase 220, synthesis phase 230, physical design phase 240, timing phase 250, and 1×N compilation 260.

In at least one embodiment, the RTL no-touch feature may eliminate the need for disrupting the RTL-only design environment with gate-level implementation details. The 1×N compiler may be configured to avoid generating RTL-level code for the no-touch building blocks. Preventing the generation of the RTL-level code may enable the embodiment to help protect proprietary design techniques, as well as maintain a technology-independent netlist.

FIG. 4B illustrates an iterative synthesis cycle with the technique of RTL no-touch. FIG. 4B also illustrates a back-annotation flow that will be described in the discussions which follow. Three distinct inputs may be fed into synthesis tool 448, as shown in FIG. 4B. One input may feed from the overall behavioral RTL (element 430). A second input may feed from an RTL no-touch file (element 446). A third input may feed from an RTL no-touch gate-level netlist database (element 444).

Each netlist in the RTL no-touch gate-level netlist database (element 444) may have a one-to-one correspondence to a corresponding element in the behavioral RTL (element 430). The RTL no-touch gate-level netlist database (element 444) may be constructed by selective output extraction of synthesis tool 448, manual intervention (element 442), or another type of automated means. The RTL no-touch file (element 446) may designate which behavioral RTL constructs (element 430) should be replaced by the gate-level netlist counterparts. Further, the RTL no-touch file (element 446) may also specify that synthesis tool 448 should avoid further manipulation of the replaced gate-level netlist counterparts. Avoiding further manipulation of the replaced gate-level netlist counterparts may be beneficial, because the synthesis tool 448 may optimize the other gate-level constructs for better overall design performance without disturbing the previously optimized netlists. Synthesis tool 448 may then generate or create the composite design netlist (element 426), which may include the RTL no-touch gate-level constructs.

### Back-Annotation

By employing a 1×N design methodology, an IC design application like VLSI design application 145 may maintain the results of optimizations performed on 1×N building blocks through a process of back-annotation. With back-annotation, a circuit designer may also perform automated optimizations of the design. In many embodiments, the circuit designer may perform the automated optimizations normally, such as the designer would in a traditional design flow. Performing the automated optimizations in a traditional manner may allow a system employing 1×N building blocks to decouple the 1×N building blocks from the tool-suite of the system. Referring back to FIG. 1, computing system 100 may perform automated optimizations on an IC design, such as a design represented by netlist 185, via tools 190 yet VLSI design application 145 may decouple 1×N building blocks 155 from tools 190.

A premise of back-annotation may be the detection and description of optimizations via 1×N building blocks. An embodiment may perform an optimization on a design and make changes to the netlist based on the optimization results. The back-annotation feature may allow the embodiment to detect the netlist changes and then describe or create updates to the 1×N building blocks corresponding to the netlist changes. FIG. 4B illustrates back-annotation via back-annotator 424. Back-annotator 424 may comprise, e.g., a software module in the stage of 1×N compilation 420, back-annotator 325 depicted in flowchart 300, or back-annotator 170 of VLSI design application 145 shown in FIG. 1.

Back-annotator 424 may read two netlists. In FIG. 4B, back-annotator 424 may read a hierarchical netlist from netlist 426 created before one or more optimization operations. Back-annotator 424 may also read a netlist that has been modified, tuned, or updated via an optimization tool or a synthesis tool. For example, back-annotator 424 may read a netlist from synthesis tool 448. Back-annotator 424 may find the 1×N building blocks in the different netlists and then detect changes of the 1×N building blocks. If back-annotator 424 finds any changes, such as by a comparison process, back-annotator 424 may update the appropriate 1×N building block 422 to reflect those optimizations. For example, back-annotator 424 may detect a change in the different netlists and update the affected parents and/or children 1×N building blocks. Back annotator 424 may detect changes such as drive strength alterations, Vt-hybridization changes, placement modifications, voltage island changes, cell-type changes, as well as other types of changes.

Since the optimizations made to the elements in the netlists are decoupled from the 1×N building blocks, back annotation for 1×N building blocks may allow an embodiment to support numerous optimization techniques, such as optimization techniques for timing, power, or area. Additionally, an embodiment may have the capability to disable one or more optimization tools or optimization features via synthesis tool 448 or back annotator 424. The quality of the starting netlist or “seed” may determine the output quality and amount of time required for automated optimization routines. Consequently, the use of iterative cycles of synthesis and back annotation may improve runtimes and result in better-optimized designs.

Back-annotator 424 may be extendable and programmed to selectively accept or ignore a specified set of changes to a specific list of 1×N building blocks. An embodiment may program back-annotator 424 to selectively accept or ignore the specified set of changes through a list of directives, which may be similar to the use of directives by existing synthesis tools. For example, if an embodiment needs a specific 1×N bit-ordering to meet a routing requirement, the embodiment may disable placement updates by fixing cell locations in the netlist or by providing back-annotator 424 with a list of 1×N building blocks for which the placement updates should be ignored. Further, depending on the embodiment, the user may be able to select the method used for optimization-exclusion. If the tool suite in an embodiment supports optimization-exclusion, the embodiment may allow a user to configure the optimization-exclusion via synthesis tool 448. However, in another embodiment that does not support optimization-exclusion, or if the optimization-exclusion is difficult or cumbersome to use, the embodiment may allow the user to configure the optimization-exclusions via back-annotator 424.

In many embodiments, synthesis tool 448 may be hierarchy-aware. In other words, synthesis tool 448 may be configured to recognize and work with hierarchical cell elements. For embodiments that have a hierarchy-aware synthesis tool 448, 1×N building block 422 may be represented as hierarchical elements, e.g., traditional hierarchical elements. Synthesis tool 448 may manipulate the hierarchical elements to produce an optimized design. For embodiments that have hierarchy-aware synthesis tool 448, the embodiments may need to perform the timing improvements or timing optimizations using the individual gates within the hierarchical elements so that timing rules such as New Delay Rules (NDRs) are not required for each individual 1×N building block 422. Otherwise, an embodiment may need to update 1×N compiler 428 to generate NDRs for each 1×N building block 422.

In many embodiments, optimizations made to 1×N building blocks may be captured via back-annotation by back-annotator 424. Placement changes allowed on a hierarchical 1×N building block 422 may be used in the physical design phase for floorplanning updates. Because the results of synthesis and automated optimization routines may largely depend on the initial quality of the netlist, or starting seed, maintaining optimizations for 1×N building blocks through back-annotation may result in a better quality synthesis result through successive iterations.

### Reassembly

As illustrated above for embodiments that do not have hierarchy-aware tools, the embodiments may flatten the 1×N building blocks before performing the optimizations. Embodiments that flatten the 1×N building blocks before performing the optimizations may detect and capture changes to the 1×N building blocks via back-annotation. However, flattening the design may eliminate the hierarchy established to maintain 1×N building blocks as individually tunable elements in the separate design phases. To address the eliminated hierarchy, various embodiments may recreate the hierarchy through a reassembly process.

Reassembler 432 may comprise a software module or other type of module for 1×N compilation 420 that uses netlist attributes created by 1×N compiler 428 to recreate the hierarchical design. Reassembler 432 may also comprise, e.g., reassembler 335 depicted in flowchart 300, or reassembler 175 of VLSI design application 145 shown in FIG. 1.

Reassembler 432 may detect changes to 1×N building blocks, such as 1×N building block 422, via back-annotation. However, because the netlist may have been flattened, the changes may not be directly applied back to the hierarchical RTL and physical design netlists. Reassembler 432 may discern the hierarchical boundaries of the flattened netlist. Plus, reassembler 432 may be configured to apply the updates for the 1×N building block 422 back to the respective hierarchical physical design netlist or RTL netlist without manual intervention.

For example, reassembler 432 may use attributes created by 1×N compiler 428, which are present in the flattened netlist, to recreate the hierarchical design. The flow process for recreating the hierarchical design via attributes of the netlist is illustrated in FIG. 4B, with the determination of the type of netlist type 426 causing reassembler 432 to reassemble flattened netlist elements. If the netlist from synthesis tool 448 is a hierarchical or non-flattened netlist, back-annotator 424 may read the netlist directly, without any modifications. However, if the netlist has been flattened, such as due to the requirements of synthesis tool 448, back-annotator 424 may read a reassembled netlist from reassembler 432.

### Iterative Physical Design Cycle

The physical design phase may comprise the part of the design process that captures or generates the physical attributes of the circuit design. For example, a VLSI design application may capture the physical attributes related to floor planning, cell and 1×N building block placement, routing between the cells/blocks, noise reduction, power bussing, and design rule checking, as just a few examples. Embodiments that employ only classical design methodologies generally lose many of the changes made during the physical design phase due to the iterations through the logic and/or synthesis design phases.

An embodiment employing a 1×N design methodology may automatically maintain changes made to the 1×N building blocks during the physical design phase via the mechanisms of back-annotation and reassembly. FIG. 4C illustrates the process of automatically maintaining changes made to the 1×N building blocks during the physical design phase via the mechanisms of back-annotator 454 and reassembler 462. For example, if a physical designer, or integrator, changes the relative spacing or bit-ordering of leaf cells in a 1×N building block 456 to ease routing congestion, an embodiment may capture the relative spacing or bit-ordering information in 1×N building block 456 and maintain the information through each successive design phase.

One flow of an iterative physical design stage may comprise reading different 1×N building blocks from a netlist of physical design 468. Depending on the type of netlist (element 452), an embodiment may reassemble the netlist via reassembler 462 and/or perform back-annotation via back-annotator 454 for the individual 1×N building blocks, such as 1×N building block 456. Embodiments may employ 1×N compiler 458 to compile the reassembled and back-annotated 1×N building blocks to generate physical design view 460.

An embodiment employing a 1×N design methodology may leverage the hierarchical nature of a physical design to make many physical design tasks more efficient through the use of scripting. For example, if an integrator wants to change the relative spacing of the leaf cells in 1×N building block 456, the embodiment employing the 1×N design methodology may not require the integrator to move each individual cell manually. Instead, the embodiment may allow the integrator to update 1×N building block 456 to reflect the desired spacing. The embodiment may then allow the integrator to recompile the design via 1×N compiler 458 and re-read the relative spacing changes into the design. The hierarchical 1×N building block 456 may be rewired on-the-fly, such as when the integrator is working on the design in physical design phase 240, so that the spacing changes are ready to use once the design is re-read. Subsequently, the integrator may resolve any potential overlaps between the 1×N building block and other random-logic cells and re-route the hierarchical connections.

An embodiment may make physical design tasks more efficient through the use of scripting for numerous types of transformations. For example, various embodiments may use scripting for relative placement of cells within 1×N building blocks, relative spacing of leaf cells, bit ordering, changes of cell types used in 1×N building blocks, and DFM/redundancy-for-test improved manufacturability implementations.

Embodiments employing dynamic updates to 1×N building blocks, such as 1×N building block 456, may not need to rely on pre-compiled sub-blocks that can be tiled together. Instead, 1×N compiler 458 may interpret the underlying physical structure of each cell and rewire 1×N building block 456 according to the cell placements described in 1×N building block 456. Interpreting the underlying physical structure and rewiring 1×N building block 456 may reduce turn-around-time for design optimizations and provide the designer or integrator with more physical detail information through each design phase.

### Iterative Timing Cycle

Due to the nature of classical timing analysis tools, designers typically perform the timing design phase using flattened designs. Based on the results of the timing analyses, a designer may manually update the design to meet timing goals. Alternatively, the timing tool may also apply updates to the design. In other words, the timing tools may use various methods to communicate the recommended changes or updates and have the updates physically implemented in the design. Embodiments employing a 1×N design methodology may update 1×N building blocks in at least two ways. A first method may comprise updating 1×N building blocks through reassembly and back-annotation, whereby the embodiment recognizes design changes and feeds the changes or alterations back to other stages in the methodology. A second method may comprise incorporating the changes via on-the-fly editing and recompilation of 1×N building blocks. This secondary method may allow for more accurate timing information in a rapid fashion via scripting from a 1×N compiler.

In a classical design flow, the timing team may make changes to the abstract or higher-level design, communicate the changes to the physical design team, and wait until the physical design team has incorporated the changes into the physical design. This interaction between the timing team and physical design team may be relatively slow in that the updates may need to be placed and routed before the updates can be analyzed in a timing analysis. Implementing the updates via placement and routing may require days. Once the physical design is ready to be analyzed for timing performance, the timing tool may take hours or days to produce the timing data for the designer depending on the complexity of the design. FIG. 4D illustrates how one or more embodiments employing a 1×N design methodology may improve this process.

FIG. 4D illustrates how an embodiment employing a 1×N design methodology may allow a designer to incorporate updates to a design that has 1×N building blocks. Depending on the type of netlist (element 472), an embodiment may reassemble the netlist via reassembler 482 and/or perform back-annotation via back-annotator 474 for an individual 1×N building block 476. The designer may be able to update 1×N building block 476, recompile the building block via 1×N compiler 478, produce a script 480 that can be read into a timing tool during a timing analysis phase 488, whereby the timing tool may update 1×N building block 476 by changing the physical implementation details of 1×N building block 476.

Changing 1×N building block 476 may not provide completely accurate timing results in some instances, because changes to 1×N building block 476 may affect other circuit elements, such as random logic gates. However, incorporating changes from a timing analysis using a 1×N design methodology may provide a greater degree of accuracy than a designer not using capabilities provided by a 1×N design methodology. Consequently, the designer may use the 1×N design methodology to reduce the time needed to update the physical design and meet timing goals, resulting in a quicker turnaround time for the design.

Script 480 generated from recompilation may not be limited to use in the timing design phase, nor to a specific set of transformations. Rather, 1×N compiler 478 may be configured to work with various tool sets for other phases of the design methodology and other desired transformations. For example, 1×N compiler 478 may be configured to work with placement and routing tools, DFM tools, design-rule checking tools, simulation tools, timing analysis tools, and other tools used in the logic, synthesis, physical design, and timing phases. Embodiments employing a 1×N building block methodology may provide the necessary design information for the various transformations through reassembly, back-annotation, and uniquification. Some embodiments may employ scripts for adding new 1×N building blocks to a design. Some embodiments may employ scripts for changing internal cell placement, internal rewiring, rewiring pins of a 1×N building block, and/or changing the functions for 1×N building blocks. Even further embodiments may employ scripts to delete specific 1×N building blocks from a design or remove internal cells of designated 1×N building blocks. As one skilled in the art will appreciate, scripts for 1×N building blocks may be used in a variety of different ways for a variety of different purposes. The example uses just cited are only a few of the possible uses.

FIG. 7 depicts an apparatus 700 having a 1×N block builder 705. 1×N block builder 705 has a GUI generator 710, a logical function selector 715, and a 1×N building block representation generator 730. 1×N compiler 740 may generate various representations of a VLSI circuit design 745. For example, the integrated circuit designer may use 1×N compiler 740 when creating netlist 185 and numerous portions of design file(s) 135 shown in FIG. 1. During compilation, 1×N compiler 740 may use the 1×N building block representation generated by 1×N building block representation generator 730 to generate behavioral representation 750, comprising one or more 1×N building blocks 755. In one or more embodiments, 1×N block builder 705 and 1×N compiler 740 may be part of a VLSI design application, such as VLSI design application 145. In an alternative embodiment, 1×N block builder 705 and 1×N compiler 740 may comprise a device used to create a VLSI circuit design, or at least a portion of the VLSI design, such as a state machine arranged to work with behavioral representation 750 and/or 1×N building blocks 755.

As illustrated in FIG. 7, 1×N compiler 740 may generate on behavioral representation 750, a logical representation 760, and a physical design representation 770. The different representation forms generated by 1×N compiler 740 may be used in the respective design phases, such as the design phases illustrated in FIG. 2. In numerous embodiments, the representations, or views, may be recompiled at any time to enable iterative cycling through the design phases. For example, the logic phase 220 may use a behavioral RTL generated by 1×N compiler 740. As the circuit designer redefines the logical implementation, he or she can fine tune, or even completely change, 1×N building blocks 755 and regenerate the behavioral RTL views, which may be reflected as behavioral representation 750, on-the-fly through recompilation. 1×N building block representations corresponding to 1×N building blocks 755 of a regenerated behavioral RTL view may be viewable and editable via GUI generator 710 and 1×N block builder 705. For example, a circuit designer may use 1×N block builder 705 to retrieve 1×N building blocks of 1×N building blocks 755, modify the 1×N building blocks via GUI generator 710, logical function selector 715, implementation selector 720, parameters selector 725, and generate modified 1×N building block representations via 1×N building block representation generator 730. 1×N compiler 740 may use the modified 1×N building block representations to generate updated integrated circuit design representations of behavioral representation 750, logical representation 760, and physical design representation 770.

Regenerating the behavioral RTL view may comprise either recreating 1×N building blocks 755 via 1×N block builder 705 for sweeping changes, or manually editing 1×N building blocks 755 for minor changes. Such manual editing may be accomplished using GUI generator 710 and 1×N block builder 705. Worth emphasizing, each iteration through a design cycle, be it a primary or secondary loop, may involve going through a 1×N compilation phase, such as 1×N compilation 260, even if no 1×N building blocks have been altered. For example, such recompilation may allow 1×N compilation phase 260 to check for changes to 1×N building blocks and update the various representations accordingly. If no 1×N building block changes are found, no updates may be required.

1×N compiler 740 may comprise one or more software modules, or other type of modules, that convert the information of 1×N building blocks in one representation form to another representation form. For example, 1×N compiler 740 may convert the information of 1×N building blocks 765 of logical representation 760 to 1×N building blocks 755 in behavioral representation 750. A circuit designer may use 1×N block builder 705 to view and/or edit one or more of the updated 1×N building block representations corresponding to building blocks of 1×N building blocks 755. Similarly, 1×N compiler 740 may convert the information of 1×N building blocks 775 of physical design representation 770 to 1×N building blocks 755 in behavioral representation 750. Again, the circuit designer may use 1×N block builder 705 to view and/or edit one or more of the corresponding updated 1×N building block representations. The information of 1×N building blocks 775 may comprise, e.g., 1×N building block elements, arrangement of the elements, connectivity information, hierarchical global wiring avoidance information, parameters, and DFM improvement information.

1×N compiler 740 may convert the information of 1×N building blocks 755, one or more of which may have been created or modified via 1×N block builder 705, to 1×N building blocks 765 in logical representation 760. Similarly, 1×N compiler 740 may convert the information of 1×N building blocks 775 of physical design representation 770 to 1×N building blocks 765 in logical representation 760. 1×N compiler 740 may convert the information of 1×N building blocks 755 of behavioral representation 750 to 1×N building blocks 775 in physical design representation 770. 1×N compiler 740 may also convert the information of 1×N building blocks 765 of logical representation 760 to 1×N building blocks 775 in physical design representation 770.

The different representation forms of circuit design 745 may vary from embodiment to embodiment, as well as within an embodiment. Behavioral representation 750 may comprise a high-level description of circuit design 745. For example, behavioral representation 750 may comprise one or more types of HDL code, behavioral RTL descriptions, user-configurable text files, C-language code, RTL netlists, or other high-level elements that describe various circuit devices, including one or more 1×N building blocks 755, cells, and/or hierarchical cells/macros.

Logical representation 760 may comprise a gate-level description of circuit design 745. For example, logical representation 760 may describe an alternative form of circuit design 745, having such components and/or elements as AND gates, OR gates, NAND gates, and NOR gates, one or more 1×N building blocks 765, and a mixture of other high-level macrocell components, such as adders, arithmetic logic units, multiplexers, and register-files.

Physical design representation 770 may comprise a low-level description of circuit design 745. For example, physical design representation 770 may describe an alternative form of circuit design 745, having such components and/or elements as nodes, wires, resistors, capacitors, inductors, contacts, poly, diffusion, many of which may have associated placement and dimensional data. Depending on the embodiment, physical design representation 770 may also comprise hierarchical information, such as hierarchical information of cells and 1×N building blocks 775. In other words, physical design representation 770 may comprise a PD netlist and/or a flattened netlist. Worth emphasizing, 1×N building blocks 775 may comprise collections of circuit elements associated with 1×N building blocks 755 and/or 765, wherein the circuit elements of physical design representation 770 may be represented in a flattened netlist.

During the design process, the circuit designer may use one or more of a variety of synthesis and performance optimization tools, such as tools 190 in FIG. 1, that generates graphical representations of circuit design 745 via display 110 and window 115, allowing the designer to create, view, simulate, and edit circuit design 745. The integrated circuit designer may have to repeatedly and iteratively use one or more of the tools before developing a final physical design representation 770 that may be fabricated. For example, the designer may use one or more logic design tools that work in conjunction with 1×N compiler 740 to create 1×N building blocks 755 in behavioral representation 750. One such logic design tool may comprise 1×N block builder 705. 1×N block builder 705 may be used by the circuit designer to create, edit, and/or view one or more of the 1×N building block representations through the various phases of design.

GUI generator 710 may generate 1×N GUIs, enabling a circuit designer to create, edit, and/or view selections for logical functions, different implementations of the logical functions, and different parameters for the respective implementations. For example, GUI generator 710 may generate the 1×N GUI depicted in FIG. 5A or 5B. Logical function selector 715, implementation selector 720, and parameters selector 725 may comprise software and/or hardware modules that enable a circuit designer to make various selections of logical functions, implementations, and parameters to customize 1×N building blocks. For example, logical function selector 715, implementation selector 720, and parameters selector 725 may comprise software modules that generate and enable selection of the logical functions of list-box 508, the implementation selections of section 510, and the parameter selections of drop-down lists 512, respectively. Logical function selector 715 may use 1×N building block library 780 to generate a list of logical functions to present to the circuit designer. Implementation selector 720 may use implementations 785, which may comprise specific implementations for the different logical functions, to present the available implementation selections. Parameters selector 725 may use parameters 790, which may comprise available cell-type parameters and/or tuning parameters available for the selected implementation, to present the selections to the circuit designer.

1×N building block representation generator 730 may use the selections that the circuit designer entered via logical function selector 715, implementation selector 720, and parameters selector 725, as well as other entered data such as the 1×N building block name and the number of specified bits for the 1×N building block, to generate a 1×N building block representation. For example, 1×N building block representation generator 730 may use the selections of the circuit designer to automatically generate the RTL text of text output window 534 and save the text in various Macfiles and/or design files.

Design checker 735 may comprise a software module that checks various behavioral, logical, and/or physical design requirements for the selections of the 1×N building block during creation and/or modification. For example, design checker 735 may enable 1×N block builder 705 to check for physical design requirements of capacitance violations, drive strength requirements, and other physical design rule requirements.

As described, one or more elements of apparatus 700 may be in the form of hardware, software, or a combination of both hardware and software. For example, in one embodiment, one or more of the modules of 1×N block builder 705 may comprise software instructions of an application stored in a tangible medium, executed in memory by a processor of a computer. In other words, one embodiment of 1×N block builder 705 may comprise portions of stored code for an application, which may generate 1×N building block representations for 1×N building blocks of integrated circuits using a closed-loop 1×N methodology, such as VLSI design application 145 shown in FIG. 1.

In alternative embodiments, one or more of the modules of 1×N block builder 705 may comprise hardware-only modules. For example, in one embodiment 1×N block builder 705 may comprise a state machine that generates 1×N GUI views for 1×N building blocks and enables the building blocks to be modified or altered.

In some embodiments, GUI generator 710, logical function selector 715, implementation selector 720, parameters selector 725, 1×N building block representation generator 730, and design checker 735 may all reside in a single device, such as in memory 140 of computing system 100 shown in FIG. 1. Alternatively, depending on the embodiment, various elements of 1×N block builder 705 may reside in two or more devices. For example, in one alternative embodiment, GUI generator 710, logical function selector 715, implementation selector 720, and parameters selector 725 may all reside in a local workstation, while 1×N building block representation generator 730 and/or design checker 735 reside in a remote server workstation.

The arrangement of apparatus 700 may vary in different embodiments. Some embodiments may have different elements than those modules depicted in FIG. 7. For example, some embodiments may have additional modules, such as a uniquifier, a back-annotator, and a reassembler. 1×N block builder 705 may be expandable, such that additional selector modules or other functional modules may be added to provide additional features or capabilities.

In other embodiments, 1×N building block 705 may include varying numbers modules, in different arrangements than the one depicted in FIG. 7. For example, one embodiment may comprise varying numbers of 1×N building block representation generators 730 and design checkers 735. For example, one embodiment may have two 1×N building block representation generators 730. Alternatively, another embodiment may have no design checkers 735.

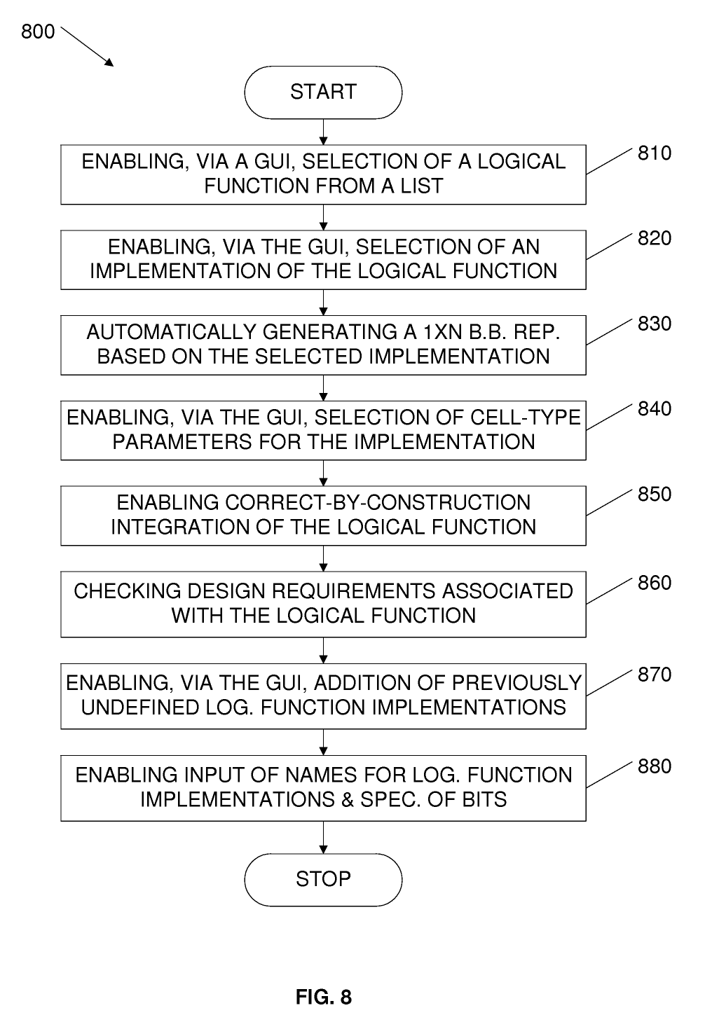

FIG. 8 shows a flowchart 800 illustrating how a designer may create a 1×N building block for an integrated circuit design using a 1×N block builder. For example, one or more embodiments may be implemented as a computer program product comprising a computer readable storage medium including instructions that, when executed by a processor generate, in an automated fashion, create a 1×N building block representation for a 1×N building block.

As illustrated in FIG. 8, the process may begin by enabling the selection of a logical function from a list of logical functions via a GUI (element 810) and enabling, via the GUI, the selection of an implementation of the logical function (element 820). For example, a designer may use the 1×N GUI of window 550 shown in FIG. 5B to create a customized 1×N building block comprising a four port multiplexer. The designer may select the logical function corresponding to a single port multiplexer from list-box 555, input a name for the 1×N building block via text input ports 560 and 565, and increase the number of bits from one to four via text input port 570 (element 880).

Upon selecting the logical function, selecting the specific implementation of the logical function, inputting the name, and increasing the number of bits, the circuit designer may request the 1×N block builder to generate a 1×N building block representation for the 1×N building block based on the selected implementation (element 830). Continuing with our example, the circuit designer may click on refresh pushbutton 575 causing the 1×N block builder to generate the text in Macfile window 580 and RTL file window 590.

The circuit designer may need to customize the cell-type parameters from the default values for the 1×N building block. To create the custom implementation of the four port multiplexer having different cell types, the circuit designer may select, via the 1×N GUI, specific cell-type parameters via drop-down lists 512 (element 840). The embodiment depicted in FIG. 8 may enable correct-by-construction integration (element 850). In other words, the hierarchical scheme implemented by the 1×N block builder may present different implementation selections based on the particular logical function selected, and different parameter selections based on particular implementation that is selected. For example, when the designer chooses a logical function from list-box 508, the 1×N block builder and the 1×N GUI may update the section 510 with possible implementations. When the designer chooses an implementation, the 1×N block builder and the 1×N GUI may update drop-down lists 512 with potential parameter selections for the selected implementation. Thus, the 1×N block builder may steer the circuit designer toward a physically realizable 1×N building block, based on the choices or selections made in each section, instead of allowing the circuit designer to make unrealizable choices.

The embodiment of FIG. 8 may check the design requirements for each logical function (element 860) and generate a 1×N building block representation for a 1×N building block that provides the physically realizable gate constructs without requiring the circuit designer understand the necessary gate construct requirements. For example, if the circuit designer chooses to implement a standard single-port latch with enable, the 1×N block builder may automatically generate a 1×N building block representation that describes the proper latch, clock splitter and overhead latch combinations for the logical function as well as the necessary connectivity.

The embodiment of FIG. 8 may also comprise an extendable 1×N block builder (element 870). That is to say, if a desired logical function or implementation is not available, the desired logical function may be added to the list from which the designer can choose. Similarly, when the 1×N building block library is expanded to allow for different selections of implementation, drive-strength, or Vt choices, the 1×N block builder lists may be updated on-the-fly to use of the expanded selections. In other words, drop-down lists 512 may be linked to the circuit library, enabling on-the-fly updates to the 1×N block builder GUI.

Flowchart 800 of FIG. 8 illustrates only one process. Alternative embodiments may implement innumerable variations of flowchart 800. For example, instead of enabling selection of cell-type parameters for the different implementations, some embodiments may not enable selection of the cell-type parameters from selection lists but require the circuit designer to manually edit the text file of the 1×N building block representation generated by the 1×N block builder. Other variations, with more elements and fewer or different elements, are possible for alternative embodiments.

Another embodiment is implemented as a program product for implementing systems and methods described with reference to FIGS. 1-8. Embodiments may take the form of an entirely hardware embodiment, an entirely software embodiment, or an embodiment containing both hardware and software elements. One embodiment is implemented in software, which includes but is not limited to firmware, resident software, microcode, etc.

Furthermore, embodiments may take the form of a computer program product accessible from a computer-usable or computer-readable medium providing program code for use by or in connection with a computer or any instruction execution system. For the purpose of describing the various embodiments, a computer-usable or computer readable medium may be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include compact disk - read only memory (CD-ROM), compact disk-read/write (CD-R/W), and DVD.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code in order to reduce the number of times code is retrieved from bulk storage during execution. Input/output or I/O devices (including but not limited to keyboards, displays, pointing devices, etc.) can be coupled to the system either directly or through intervening I/O controllers.

Those skilled in the art, having the benefit of this disclosure, will realize that the present disclosure contemplates using a 1×N block builder and a 1×N GUI to design integrated circuits via 1×N building blocks in a closed-loop methodology. The form of the embodiments shown and described in the detailed description and the drawings should be taken merely as examples. The following claims are intended to be interpreted broadly to embrace all variations of the example embodiments disclosed.

Although the present disclosure and some of its advantages have been described in detail for some embodiments, one skilled in the art should understand that various changes, substitutions, and alterations can be made herein without departing from the spirit and scope of the disclosure as defined by the appended claims. Although specific embodiments may achieve multiple objectives, not every embodiment falling within the scope of the attached claims will achieve every objective. Moreover, the scope of the present application is not intended to be limited to the particular embodiments of the process, machine, manufacture, composition of matter, means, methods, and steps described in the specification. As one of ordinary skill in the art will readily appreciate from this disclosure, processes, machines, manufacture, compositions of matter, means, methods, or steps presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

What is claimed is:

1. A method, comprising:
enabling, via a graphical user interface (GUI), selection of a logical function from a list, wherein the logical function is for a 1×N building block of an integrated circuit design;
enabling, via the GUI, selection of an implementation from a number of implementations of the logical function; and
generating, automatically, a 1×N building block representation of the logical function based on the selected implementation, wherein the 1×N building block representation comprises a register transfer level (RTL) description of the 1×N building block.

2. The method of claim 1, further comprising enabling, via the GUI, selection of a tuning parameter for the implementation.

3. The method of claim 2, wherein the enabling the selection comprises presenting the tuning parameter in a drop-down list of numerous tuning parameters.

4. The method of claim 2, wherein the enabling the selection comprises presenting circuit choices for at least one of drive-strength, Vt-hybridization, size, orientation, and a specific overhead implementation.

5. The method of claim 1, further comprising enabling, via the GUI, input of a name for the 1×N building block and specification of a number of bits of the 1×N building block.

6. The method of claim 1, further comprising checking physical design requirements associated with the 1×N building block representation.

7. The method of claim 6, wherein the checking design requirements comprises checking for at least one of a capacitance violation, a drive strength requirement, and a physical design rule requirement.

8. The method of claim 1, wherein the enabling the selection of the implementation comprises presenting the implementation in a drop-down list of numerous implementations of the logical function, wherein further the numerous implementations correspond to numerous physical realizations of the logical function.

9. The method of claim 1, wherein the generating the 1×N building block representation comprises creating, in a text-based window, text for a macro-definition file and text for a Verilog instantiation of the 1×N building block for the macro-definition file, wherein further the text of the Verilog instantiation comprises input for a 1×N compiler.

10. The method of claim 9, further comprising generating a physical design representation based on the 1×N building block representation, wherein the physical design representation comprises one of a flat netlist, a hierarchical netlist, and a partially flattened netlist and generating, via the 1×N compiler, a logical representation via the physical design representation.

11. An apparatus, comprising:
a graphical user interface (GUI) generator to generate a GUI for a display;
a logical function selector to select a logical function from a number of logical functions for a 1×N building block of an integrated circuit design, wherein the selection of the logical function is via the GUI;
an implementation selector to select, via the GUI, an implementation of the logical function, wherein the implementation selector is configured to select the implementation from a number of implementations; and
a 1×N building block representation generator to generate a 1×N building block representation of the 1×N building block based on the selected implementation.

12. The apparatus of claim 11, further comprising a parameter selector to select one or more tuning parameters for the selected implementation.

13. The apparatus of claim 12, wherein the tuning parameters comprise drive strength and Vt-hybridization.

14. The apparatus of claim 11, further comprising a design checker to check for design violations of the 1×N building block representation.

15. The apparatus of claim 11, further comprising a 1×N compiler to generate a physical design representation via the 1×N building block representation, wherein the 1×N compiler is configured to generate an updated behavioral representation and an updated logical representation via the physical design representation, wherein further the physical design representation comprises at least one of a flat netlist and a partially flat netlist.

16. The apparatus of claim 15, wherein the behavioral representation comprises an RTL netlist and the logical representation comprises a gate-level netlist.

17. The apparatus of claim 11, wherein the at least one of the logical function selector and the implementation selector is configured to accept manual configuration from a user and retrieve a selection for the 1×N building block from a 1×N building block library.

18. The apparatus of claim 11, wherein the logical function selector and the implementation selector and a parameter selector are hierarchically arranged to update implementation selections based on the selected logical function and update parameter selections based on the selected implementation.

19. The apparatus of claim 11, wherein the 1×N building block representation generator is configured to generate an updated 1×N building block representation based on an alteration via at least one of a synthesis tool, a physical design tool, a layout tool, and a timing analysis tool.

20. A computer program product comprising:
a computer readable storage medium including instructions that, when executed by a processor:
enable selection of a logical function from a list via a graphical user interface (GUI), wherein the logical function is for a 1×N building block of an integrated circuit design;
enable selection of an implementation from a number of implementations of the logical function; and
generate a 1×N building block representation of the logical function based on the selected implementation.

21. The computer program product of claim 20, further comprising instructions that enable the selection of parameters for a selected implementation, wherein presented parameters for selection change based on the selection of the implementation of the logical function.

22. The computer program product of claim 20, further comprising instructions that enable updates to be made to the list during a phase of the integrated circuit design, wherein the enablement of the updates is via a link for a circuit library and a drop-down list.

23. The computer program product of claim 20, further comprising instructions that enable a new implementation of the logical function to be added to the list via a save of a 1×N building block representation for the new implementation.

24. The computer program product of claim 20, further comprising instructions that are configured to accept inputs from a circuit designer and accept inputs from a 1×N building block library, to generate the 1×N building block representation.
